(19) United States
(12) Patent Application Publication
(10) Pub. No.: US 2023/0330665 A1
(43) Pub. Date: Oct. 19, 2023

(54) UNITARY CARTRIDGE BODY AND ASSOCIATED COMPONENTS AND METHODS OF MANUFACTURE

(71) Applicants: Douglas B. Dority, Sunnyvale, CA (US); Alan E. Tucker, Sunnyvale, CA (US)

(72) Inventors: Douglas B. Dority, Sunnyvale, CA (US); Alan E. Tucker, Sunnyvale, CA (US)

(21) Appl. No.: 18/184,326

(22) Filed: Mar. 15, 2023

Related U.S. Application Data
(60) Provisional application No. 63/319,993, filed on Mar. 15, 2022.

(51) Int. Cl. B01L 3/00

(52) U.S. Cl. CPC B01L 3/502715; B01L 3/502738; B01L 3/502761; B01L 2200/04; B01L 2200/0647; B01L 2200/10; B01L 2200/16; B01L 2300/0654; B01L 2300/0681; B01L 2300/0864; B01L 2400/0487; B01L 2400/0644

(57) ABSTRACT

Improved sample cartridges, valve assemblies and methods of manufacture and assembly are provided herein. Such systems can include a sample processing cartridge having a unitary cartridge body with integral syringe tube and valve interface. Such systems can further includes valve assemblies with an overmolded gasket and gaskets with a protruding conical valve sealing surface. Various additional features can include thin film sealing for cartridge as well as valve assemblies for chemical lysis. Thin film sealing for cartridge lids can include various multi-layered designs to facilitate injection and sealing of reagents within the cartridge. Magnetic separation features are also included. Such features can be included in various design iterations as needed for compatibility with existing technologies and to accommodate needs for manufacturing workflows.

### CROSS-REFERENCES TO RELATED APPLICATIONS

This application is a Non-Provisional of and claims the benefit of priority of U.S. Provisional Application No. 63/319,993 filed Mar. 15, 2022, the entire contents of which are incorporated herein by reference.

### BACKGROUND OF THE INVENTION

The present invention relates generally to the field of biochemical analysis, and in particular to sample cartridges for analyzing a fluid sample.

The analysis of fluids such as clinical or environmental fluids generally involves a series of processing steps, which may include chemical, optical, electrical, mechanical, thermal, or acoustical processing of the fluid samples. Whether incorporated into a bench-top instrument, a disposable cartridge, or a combination of the two, such processing typically involves complex fluidic assemblies and processing algorithms. Conventional systems for processing fluid samples employ a series of chambers each configured for subjecting the fluid sample to a specific processing step. As the fluid sample flows through the system sequentially from chamber to chamber, the fluid sample undergoes the processing steps according to a specific protocol.

In recent years, there has been considerable development in the field of biological testing devices that facilitate manipulate a fluid sample within a sample cartridge to prepare the sample for biological testing by polymerase chain reaction (“PCR”). One notable development in this field is the GeneXpert sample cartridge by Cepheid. The configuration and operation of these types of cartridges can be further understood by referring to U.S. Pat. No. 6,374,684 entitled “Fluid Control and Processing System,” and U.S. Pat. No. 8,048,386 entitled “Fluid Processing and Control.” While these sample cartridges represent a considerable advancement in the start of the art when developed, as with any precision instrument, there are certain challenges in regard to performance and use of such systems and processes. Moreover, the precise requirements of a particular assay and different target types (e.g. bacterial or viral) necessitates the development of cartridges that operate in a robust and consistent manner. These demands of sample cartridges, which entails fluid manipulation between various chambers and transport into a reaction chamber requires complex interaction between multiple mechanical systems.

In order to continually improve performance and increase capabilities of sample cartridges, the standard approach in the industry has been to incorporate additional componentry and mechanical systems into the existing devices. While this approach is widely used, in practice, increasing the complexity and componentry of sample cartridges presents multiple challenges in both manufacture and operation of the devices, including incompatibilities with existing interfaces, unpredictable errors and inconsistencies in performance.

Thus, there is a need for sample cartridges that maintain and/or improve performance and versatility of sample cartridge devices while simplifying the cartridge design and reduce design complexities in order to improve manufacturing and assembly and provide cartridges that operate in a more robust and consistent manner. There is further need for sample cartridges having improved design features and functionality that are compatible with existing interfaces in order to reduce costs and improve availability to patients.

### BRIEF SUMMARY OF THE INVENTION

The present invention pertains to sample cartridge devices and associated components, particularly sample cartridge devices capable that perform sample preparation and testing of a biological sample within the cartridge.

The present invention pertains to various improvements and features for sample cartridges having a cartridge body with multiple chambers for processing a biological sample for analysis within an attached reaction vessel. Such sample cartridges can include a syringe tube fluidically connected to a rotatable valve assembly rotation which facilitates transport of fluid sample between the chambers and reaction vessel via the syringe tube. The valve body can include a chamber in which a filter is supported, through which the biological sample is filtered, before an elution from the filter is advanced into a reaction vessel that extends from the body of the cartridge and is fluidically attached to the cartridge for analytical testing. The valve body is supported beneath the multiple chambers in a base of the sample cartridge. The sample cartridge further includes a lid that is fluidically sealed atop the multiple chambers, thereby fluidically sealing each chamber relative each other. These aspects can be further understood by referring to U.S. Pat. No. 6,374,684 entitled “Fluid Control and Processing System,” filed Aug. 25, 2000; U.S. Pat. No. 8,048,386 entitled “Fluid Processing and Control,” filed Feb. 25, 2002; and US 2017/0023281 entitled “Thermal Control Device and Methods of Use” filed Jul. 22, 2016; each of which is incorporated herein by reference in its entirety for all purposes. The sample cartridge is configured to be received within a processing module that operates the cartridge to perform sample preparation and analytical testing. The desired analyte is typically intracellular material (e.g., nucleic acid, proteins, carbohydrates, or lipids). In some embodiments, the analyte is nucleic acid which the cartridge separates from the fluid sample and holds for amplification (e.g., using PCR or an isothermal amplification method) and optical detection. It is appreciated that the invention described herein can pertain to any fluid sample cartridge having any of the above features or any combination thereof.

In one aspect, the invention pertains to a sample cartridge of a unitary design in which various components are integrally formed. In some embodiments, the cartridge design includes a unitary cartridge body having multiple chambers, a syringe tube and a base. In another aspect, the invention pertains to valve assemblies having various improvements, including any of: an overmolded gasket, a protruding non-flat gasket, a snap-fit tube mount for a reaction vessel, an inclined filter face and filter support ribs, a unitary valve assembly for chemical lysis, and thin film sealing of the cartridge lid. In yet another aspect, the invention pertains to a “no-loop” design of the sample cartridge and/or reaction vessel and methods of manufacture in which one channel is open to atmosphere or is closed and relies on pressurization of headspace for fluid flow. In yet another aspect, the invention pertains to sample cartridges and valve bodies incorporating a magnet and magnetic capture chamber for magnetic separation. Various tools and manufacturing methods are also detailed herein.

In accordance with an aspect of the invention, a fluid control and processing system comprises a housing having a plurality of chambers, and a valve body including a fluid processing region continuously coupled fluidically with a fluid displacement region. The fluid displacement region is depressurizable to draw fluid into the fluid displacement region and pressurizable to expel fluid from the fluid displacement region. The valve body includes at least one external port, the fluid processing region is fluidically coupled with at least one external port, and the fluid displacement region is fluidically coupled with at least one external port of the valve body. The valve body is adjustable with respect to the housing to allow the at least one external port to be placed selectively in fluidic communication with the plurality of chambers.

In some embodiments, the sample cartridge employs a rotary valve configuration to control fluidic movement within the cartridge that allows for selective fluidic communication between a fluid sample processing region and a plurality of chambers in the cartridge. Non-limiting exemplary chambers can include, a sample chamber, a reagent chamber, a waste chamber, a wash chamber, a lysate chamber, an amplification chamber, and a reaction chamber. The fluid flow among the fluid sample processing region and the chambers is controlled by adjusting the position of the rotary valve. In this way, the metering and distribution of fluids in the cartridge can be varied depending on the specific protocol, which allows sample preparation to be adaptable to different protocols such as may be associated with a particular sample type for different types of analysis or different types of samples. For example, the sample cartridge can include a means for cell lysis, e.g., a sonication means so that bacteria and cells in a fluid sample to be analyzed can be lysed. Additional lysis means suitable for use with the instant invention are well known to persons of skill in the art, and can include, chemical lysis, mechanical lysis, and thermal lysis. In some embodiments, the sample includes bacteria, eukaryotic cells, prokaryotic cells, parasites, or viral particles.

In some embodiments, the cartridge is configured to facilitates sample processing steps that are performed from initial sample preparation steps, intermediate processing steps, and further processing steps to facilitate a detection of a target analyte in the biological sample with an attached reaction vessel. For example, sample processing can include preliminary preparation steps, such as filtering, grinding, mincing, concentrating, trapping debris or purifying a rough sample, or steps for fragmenting of DNA or RNA of the target analyte, such as by sonication or other mechanical or chemical means. Sample processing can include various intermediate processing steps, such as filtering, chromatography, or further processing of nucleic acids in the sample, including but not limited to chromatography, bisulfite treatment, reverse transcription, amplification, hybridization, ligation, or fragmentation of DNA or RNA. Sample processing may further include final processing steps, such as final amplification, hybridization, sequencing, chromatographic analysis, filtering and mixing with reagents for a reaction to detect the target analyte, which detection can include optical, chemical and/or electrical detection. While the sample cartridge typically performs analytical testing in an attached reaction tube or reaction vessel, it is appreciated that the sample cartridge can utilize various other means as well, e.g. a semiconductor chip that can be incorporated into the reaction vessel that extends from the body of the cartridge.

In some embodiments, the sample processing device can be a fluid control and processing system for controlling fluid flow among a plurality of chambers within a cartridge, the cartridge comprising a housing including a valve body having a fluid sample processing region continuously coupled fluidically with a fluid displacement chamber. The fluid displacement chamber is depressurizable to draw fluid into the fluid displacement chamber and pressurizable to expel fluid from the fluid displacement chamber. The fluid sample processing region includes a plurality of fluid transfer ports each fluidically coupled with one of a plurality of external ports of the valve body. The fluid displacement chamber is fluidically coupled with at least one of the external ports. The valve body is adjustable with respect to the plurality of chambers within the housing to allow the external ports to be placed selectively in fluidic communication with the plurality of chambers. In some embodiments, the valve body is adjustable with respect to the housing having multiple chambers, to place one external port at a time in fluidic communication with one of the chambers.

In some embodiments of the cartridge, the fluid sample processing region can be disposed between the fluid displacement chamber and at least one fluid transfer port. The term “fluid processing region” refers to a region in which a fluid sample is subject to processing including, without limitation, chemical, optical, electrical, mechanical, thermal, or acoustical processing. For example, chemical processing may include a chemical treatment, a change in pH, or an enzymatic treatment; optical processing may include exposure to UV or IR light; electrical processing may include electroporation, electrophoresis, or isoelectric focusing; mechanical processing may include mixing, filtering, pressurization, grinding or cell disruption; thermal processing may include heating or cooling from ambient temperature; and acoustical processing may include the use of ultrasound (e.g. ultrasonic lysis). In some embodiments, the fluid processing region may include an active member, such as a filter, to facilitate processing of the fluid. In some embodiments, filtration or other active processing steps can occur in one of the cartridge chambers prior to the sample fluid entering the fluid sample processing region. Additional active members suitable for use with the instant invention are well known to persons of skill in the art. In some embodiments, an energy transmitting member is operatively coupled with the fluid sample processing region for transmitting energy thereto to process fluid contained therein. In some embodiments, the valve body includes a crossover channel, and the valve body is adjustable with respect to the plurality of chambers to place the crossover channel in fluidic communication with two of the chambers concurrently.

The cartridge housing includes one or more branches that extend to one or more transfer ports to which a reaction vessel can be attached so as to facilitate transfer of fluid sample from a chamber of the cartridge into the reaction vessel. In some embodiments, the reaction vessel extends from the housing of the cartridge. These aspects can be understood further by referring to U.S. Pat. No. 8,048,386. It is understood that fluid may flow in either direction into or out of the transfer ports in various embodiments fluid flow is not limited in any particular direction. For example, in an embodiment having a pair of transfer ports, air may be pumped into or evacuated from one of the pair of transfer ports to facilitate flow of the fluid sample into a conduit of the reaction vessel through the fluid transfer port.

In some embodiments, the sample cartridge is configured for processing an unprepared sample, which can include steps of: receiving a sample cartridge in a cartridge receiver of a module, the sample cartridge including a biological fluid sample to be analyzed, a plurality of processing chambers fluidically interconnected by a moveable valve body; receiving an electronic instruction to process the biological sample into a prepared sample from the module; performing a sample preparation method in the sample cartridge to process the biological fluid sample into the prepared sample; transporting the prepared sample into a reaction vessel fluidically coupled with the sample cartridge; and performing analysis of the biological fluid sample within the reaction vessel. In some embodiments, transporting the sample may include steps of: moving a cartridge interface unit to move the valve body to change fluidic interconnections between the plurality of sample processing chambers; applying pressure to a pressure interface unit to move fluid between the plurality of processing chambers according to position of the valve body; and fluidically moving the prepared sample into the reaction vessel. Performing analysis of the fluid sample within the reaction vessel with the module.

### BRIEF DESCRIPTION OF THE DRAWINGS

FIGS. 1A-1C show several views of a unitary cartridge design in accordance with some embodiments of the invention. FIG. 1A shows a view of the unitary cartridge in an upright position, FIG. 1B shows an underside view of the unitary cartridge showing the valve assembly, and FIG. 1C shows an underside view of the unitary cartridge with the valve assembly removed with an exploded view of the valve assembly.

FIGS. 2A-2B show an assembled and exploded view of a conventional sample cartridge.

FIG. 3 shows a top view of the cartridge body in accordance with some embodiments.

FIG. 4 shows an underside view of the base of the unitary cartridge body showing the valve interface in accordance with some embodiments.

FIG. 5 shows an underside view of the base of the unitary cartridge body showing the valve interface and the tube mount in accordance with some embodiments.

FIG. 6 shows a cap of a valve assembly in accordance with some embodiments.

FIG. 7 shows a valve body and filter of a valve assembly in accordance with some embodiments.

FIG. 8 shows an overmolded gasket of a valve assembly in accordance with some embodiments.

FIG. 9 shows a valve assembly in accordance with some embodiments.

FIG. 10 shows the valve assembly attached within a unitary cartridge in accordance with some embodiments.

FIGS. 11A-11D show various conventional valve assembly and syringe tubes, which can be modified in accordance with some embodiments.

FIG. 12 shows a conventional valve assembly with a syringe tubes and glass filter for chemical lysis.

FIG. 13 shows a unitary valve assembly with syringe tubes and glass filter for affinity capture in accordance with aspects of the invention.

FIGS. 14A-14E show an exemplary method of fabricating the unitary valve assembly with syringe tube in accordance with aspects of the invention.

FIG. 15 shows the valve body and fluidic ports of the unitary valve assembly in accordance with aspects of the invention.

FIG. 16 shows an exemplary tool for fabricating the unitary valve assembly with syringe tube in accordance with aspects of the invention.

FIGS. 17A-17D show a “no-loop” sample cartridge and reaction vessel in accordance with aspects of the invention.

FIG. 18 shows an exemplary tool for fabricating the “no-loop” sample cartridge and reaction vessel of FIG. 17C.

FIGS. 19A-19B show a cut-away view of a thin film sealed sample cartridge configured for “no-loop” control of a conventional reaction vessel, in accordance with some embodiments.

FIGS. 20 shows a sample cartridge thin film lid inserts in accordance with some embodiments.

FIGS. 21A-27 show valve assemblies and cartridges configured with magnets and magnetic capture chambers for magnetic separation in accordance with some embodiments.

FIGS. 28A-28B shows a collapsing core tool in accordance with some embodiments.

FIG. 29 shows an annular valve body snap of a cartridge body in accordance with some embodiments.

FIGS. 30A-30B show an exemplary collapsible core tool for forming the valve interface of the unitary cartridge in accordance with some embodiments.

FIG. 31A-31B shows a tube snap-fit interface of the cartridge body formed by A side motion in accordance with some embodiments.

FIG. 32 shows a tube snap-fit interface of the cartridge body formed by a collapsible core tool, in accordance with some embodiments.

FIGS. 33A-33B shows an exemplary collapsible core tool for forming the tube snap-fit interface of the cartridge body, in accordance with some embodiments.

FIGS. 34A-34B shows the collapsible core of the tool for forming the tube snap-fit interface of the cartridge body, in accordance with some embodiments.

FIG. 35 show the front face of the cartridge body as formed by a tool having a slide and collapsing fingers, in accordance with some embodiments.

FIGS. 36A-36B show an exemplary tool slide and collapsing fingers for forming the front face of the cartridge body, in accordance with some embodiments.

FIG. 37 shows a single slide tool for forming the front face of the cartridge body, in accordance with some embodiments.

FIG. 38 shows the unitary cartridge with integrated syringe tube, in accordance with some embodiments.

FIG. 39 shows a conical shaped valve assembly, in accordance with some embodiments.

FIG. 40 shows a unitary cartridge with integral lid tooled to flip over and cover the cartridge chambers, in accordance with some embodiments.

FIG. 41 shows a tool for tooling the integral lid of the unitary cartridge, in accordance with some embodiments.

### DETAILED DESCRIPTION OF THE INVENTION

The present invention relates generally to a system, device and methods for fluid sample manipulation and analysis, in particular, sample cartridges that facilitate processing and analytical testing of biological samples.

### I. System Overview

In one aspect, the invention pertains to a sample cartridge of unitary design in which various components are integrally formed, and to various other improvements of the sample cartridge, valve assembly, lid sealing, and attached reaction vessel. The sample cartridge device can be any device configured to perform one or more process steps relating to preparation and/or analysis of a biological fluid sample according to any of the methods described herein. In some embodiments, the sample cartridge device is configured to perform at least sample preparation. The sample cartridge can further be configured to perform additional processes, such as detection of a target nucleic acid in a nucleic acid amplification test (NAAT), e.g., Polymerase Chain Reaction (PCR) assay, by use of a reaction tube attached to the sample cartridge. In some embodiments, the reaction tube extends from the body of the sample cartridge. Preparation of a fluid sample generally involves a series of processing steps, which can include chemical, electrical, mechanical, thermal, optical or acoustical processing steps according to a specific protocol. Such steps can be used to perform various sample preparation functions, such as cell capture, cell lysis, binding of analyte, and binding of unwanted material. A sample cartridge suitable for use with the invention, includes one or more transfer ports through which the prepared fluid sample can be transported into an attached reaction vessel for analysis. In some embodiments, the transfer ports and fluidic passages contain bubble traps to capture air and prevent it from entering the reaction vessel. In some embodiments the fluidic passages are designed to help remove air from the reaction tube as it is displaced with the processed fluid sample to be analyzed.

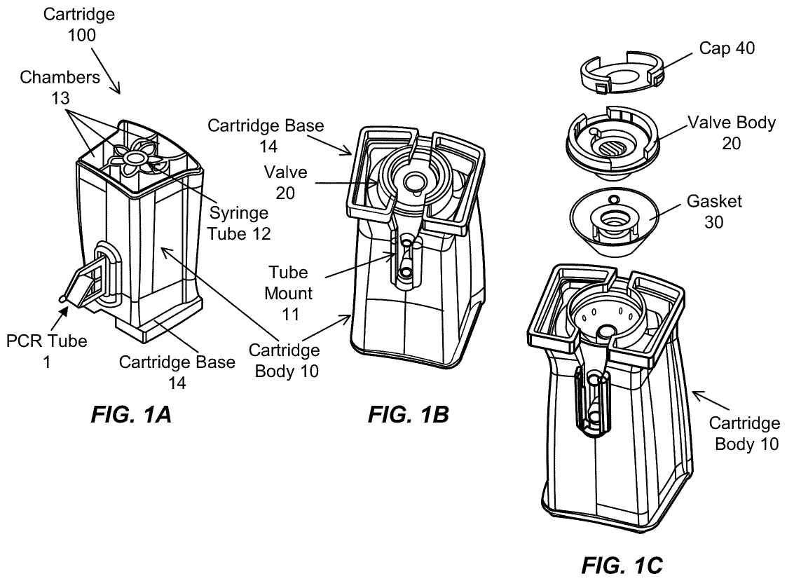

FIG. 1A illustrates an exemplary universal sample cartridge 100 (lid not shown) suitable for sample preparation and analytics testing by PCR when received in an instrument module in accordance with some embodiments. The sample cartridge has attached thereto, a reaction vessel 1 (“PCR tube”) adapted for analysis of a fluid sample processed within the sample cartridge 100. In some embodiments the reaction tube extends from the cartridge body. Such a sample cartridge 100 includes various components including the cartridge body 10 having multiple chambers 13 for processing of the fluid sample, which typically include sample preparation before analysis. An instrument module, in which the cartridge is received, facilitates the processing steps needed to perform sample preparation and the prepared sample is transported through one of a pair of transfer ports into fluid conduit of the reaction vessel 1 attached to the housing of the sample cartridge 100. The prepared biological fluid sample is then transported into a chamber of the reaction tube 1 where the biological fluid sample undergoes nucleic acid amplification. In some embodiments, the reaction vessel contains multiple isolated chambers in which different reactions can take place. In some embodiments, the reaction vessel contains 2, 3, 4, 5 or more separate reaction chambers. In some embodiments, the amplification is a polymerase chain reaction. In some embodiments, concurrent with the amplification of the biological fluid sample, an excitation means and an optical detection means of the module is used to detect optical emissions that indicate the presence or absence of a target nucleic acid analyte of interest, e.g., a bacteria, a virus, a pathogen, a toxin, or other target analyte. In some embodiments, optical detection is performed on-board the cartridge device, for example with a camera chip within the reaction vessel. It is appreciated that such a reaction vessel could include various differing chambers, conduits, or micro-well arrays for use in detecting the target analyte. The sample cartridge can be provided with means to perform preparation of the biological fluid sample before transport into the reaction vessel. Any chemical reagent required for viral or cell lysis, or means for binding or detecting an analyte of interest (e.g. reagent beads) can be contained within one or more chambers of the sample cartridge, and as such can be used for sample preparation.

An exemplary use of a reaction vessel for analyzing a biological fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of a conventional sample cartridge and associated module are shown and described in U.S. Pat. No. 6,374,684, entitled “Fluid Control and Processing System” filed Aug. 25, 2000; U.S. Pat. No, 8,048,386, entitled “Fluid Processing and Control,” filed Feb. 25, 2002; and U.S. Provisional Application No. 63/217,672 filed Jul. 1, 2021 and entitled “Universal Assay Cartridge and Methods of Use”, the entire contents of which are incorporated herein by reference in their entirety for all purposes.

Various aspects of the sample cartridge 100 can be further understood by referring to U.S. Pat. No. 6,374,684, which describes certain aspects of a conventional sample cartridge and various components in greater detail. Such conventional sample cartridges can include a fluid control mechanism, such as a rotary fluid control valve, that is connected to the chambers of the sample cartridge. Rotation of the rotary fluid control valve permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module includes a motor such as a stepper motor that is typically coupled to a drive train that engages with a feature of the valve in the conventional sample cartridge to control movement of the valve in coordination with movement of the syringe, thereby resulting movement of the fluid sample according to the desired sample preparation protocol. The fluid metering and distribution function of the rotary valve according to a particular sample preparation protocol is demonstrated in U.S. Pat. No. 6,374,684. It is appreciated that the above noted aspects of the conventional sample cartridge and associated module can be utilized in the unitary cartridge design as well.

Details of the unitary cartridge design as well as various other improvements over the conventional sample cartridge can be further understood by referring to FIGS. 1A-1C, 3-10 and 20-30B. In some embodiments, the improved cartridge design can include any of the following features:
(i) a cartridge body having multiple chambers having an integrally formed syringe lumen through which the biological sample is selectively injected into selected chambers selected by rotation of a valve body disposed in the base;
(ii) a gasket incorporated into the valve body, such as by overmolding, that can include an upwardly protruding valve interface (e.g. angled, convex, conical) that interfaces with the gasket of the valve body;
(iii) a unitary cartridge body that includes an integrally formed cartridge base configured to receive the valve body from an underside thereof;
(iv) a tube mount configured so that a reaction vessel can be attached and/or removed after cartridge assembly, such as by a snap-fit interface;
(v) improved valve body designs having an inclined or angled filter face or filter support ribs to improve fluid flow through a filter membrane and/or filter column;
(vi) a thin film insert that facilitates sealing between the lid and the cartridge body; and
(vii) a cartridge base that is essentially square shaped such that the cartridge can stand on a flat surface without additional support;
(viii) a cartridge with a separate molded foot and tube mount such that the reaction tube can be affixed to the cartridge after assembly with the foot;
(ix) a cartridge with an integrated funnel;
   (x) a cartridge with a gasketless luer seal for the reaction tube; and
(xi) a cartridge with an integrated lid
   It is appreciated that an improved sample cartridge can include any of the above features or any combination thereof, to provide improvements in form and function as compared to conventional designs.

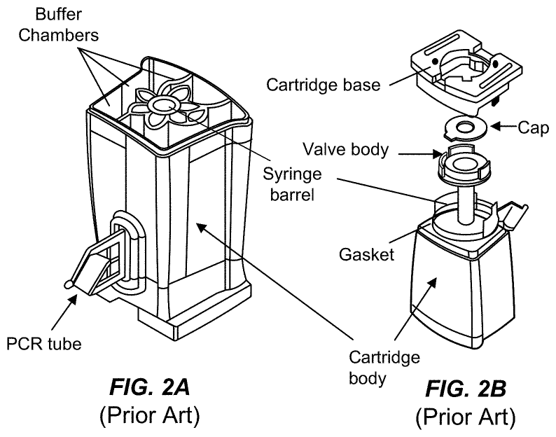

In contrast to the above described features, conventional cartridges of similar design (such as that shown in FIGS. 2A-2B) utilize an assembly of various components that form the cartridge body, including a separate syringe tube extending through the syringe barrel, and a separate base with tube mount that is removed to allow insertion of a flat valve body and flat gasket against the cartridge body. While this design represented an advancement in the state of the art at the time it was developed, this assembly requires multiple separate components, more complex assembly, and may be prone to performance challenges associated with these separate components. Further, the separate base with attached tube mount design requires insertion of the reaction vessel during initial assembly, which inhibits subsequent removal/replacement of the reaction vessel. The various cartridge design features of the present invention described above provide marked improvements in regard to manufacture, assembly and performance. In some respects, the noted features simplify the design so as to streamline manufacture and assembly, while providing the same or better performance. In some embodiments, the cartridge is configured to allow for complete manufacture of the cartridge including addition of reagents before attaching the reaction tube or associated devices. Advantageously, this configuration can avoid wasting reaction tubes, particularly specialized reaction tubes having costly materials, componentry or devices, since cartridge defects can be detected before attaching the reaction tube to the cartridge.

In regard to the first aspect, the unitary cartridge body is formed such that the separate syringe tube in the conventional design has been eliminated, and is integrally formed with the cartridge body. The syringe lumen can be reduced in diameter which allows an increase in the size of the multiple chambers surrounding the syringe tube. Forming the syringe lumen integrally with the cartridge body simplifies the manufacture and assembly of the cartridge.

In regard to the second aspect, the improved sample cartridge includes a gasket that is incorporated into the valve body. In some embodiments, the gasket is no longer flat, but is angled or curved to protrude upwards, which allows higher normal forces (i.e. normal to the gasket plane) to be generated within the gasket material to provide improved sealing and pressurization as compared to the conventional design having a flat gasket requiring substantially higher normal force to attain the same level of sealing and pressurization.

In regard to the third aspect, the cartridge body can be integrally formed with the cartridge base. In some embodiments, the cartridge base is configured so that the valve assembly is insertable from an underside thereof. In some embodiments, the cartridge base is configured with a negative conical valve surface with multiple openings corresponding to the multiple chambers to interface with a conical gasket of the valve assembly, the gasket having one or more holes for aligning with one or more selected openings of the interface upon rotation of the valve assembly. In some embodiments, the unitary cartridge body can be configured to receive the valve body from an underside thereof.

In regard to the fourth aspect, the cartridge can include a tube mount that is configured to receive and securely affix to a reaction vessel without requiring disassembly of the cartridge. In some embodiments, the reaction vessel flange is configured to releasably attach to a corresponding flange of the reaction vessel so that the reaction vessel can be removed, replaced or exchanged with a differing type of reaction vessel. This is advantageous as it allows specialized reaction vessels to be attached to the sample cartridges after initial assembly. In some embodiments, the reaction vessel flange of the cartridge body is a snap-fit design. In some embodiments, the tube mount is configured to securely affix the reaction vessel, after which it cannot be readily removed.

In regard to the fifth aspect, the sample cartridge can include valve body designs that are modified to control fluid flow of the biological sample. In some embodiments, the valve body includes a filter plane angled relative a horizontal plane so as to slow fluid flow of the biological sample as it flows toward the filter so as to more uniformly spread across the filter. In some embodiments, the valve assembly includes multiple support ribs that support the filter to ensure more uniform flow of the fluid sample through the filter. In some embodiments, the valve body includes multiple walls defining a filter chamber and a flowpath for the fluid flow that direct the fluid sample into the filter chamber. The filter chamber can be sealed by a membrane sealed over the multiple walls. It is appreciated that these modified valve designs can be used in a conventional valve assembly having a separate syringe tube attached thereto or a valve assembly configured for use with the unitary cartridge body described above.

In regard to the sixth aspect, the cartridge can include a thin film lid insert having one or more layers that facilitate sealing atop the cartridge, between the cartridge and lid. The thin film insert can include one or more layers to facilitate sealing of the multiple chambers after filling with reagents, yet still allow a user to input the fluid sample in the cartridge after sealing. The lid can include a thin film insert that is sealable by as heat sealing.

### II. Example Cartridge

### A. Overview

FIGS. 1A-1C illustrates the improved design in exemplary sample cartridge device 100 fluidically coupled with a reaction vessel 1. The fluid sample cartridge 100 is adapted for insertion into a bay of a module having an instrument interface configured to perform one or more processing steps on a fluid sample contained within the fluid sample cartridge through manipulation of the fluid sample cartridge. The processing steps can include any steps associated with sample preparation, transport of fluid sample, and analytical testing. As shown in FIG. 1A, this cartridge device 100 includes an unitary cartridge body 10 that includes an integrally formed tube mount 11, syringe tube 12, multiple chambers 13 disposed around the syringe tube, and cartridge base 14. The tube mount 11 is configured so as to receive the reaction vessel (e.g. PCR tube 1) after assembly of the cartridge. As shown in FIG. 1B, the underside of the cartridge base 14 is configured to receive a valve 20. Rotation of the valve selects a given chamber of the multiple chambers so that injection of fluid sample through the syringe tube transports the fluid sample into the selected chamber for processing and/or transports the prepared fluid sample into the reaction vessel for analytical testing. As shown in FIG. 1C, the valve assembly includes the valve body 20, a gasket 30 and cap 40. The cap 40 is securely attached (e.g. by a snap-fit) to the underside of the valve body and the gasket can be incorporated into the valve assembly, such as by overmolding with the valve body, as described further below.

In contrast, a conventional sample cartridge is shown in FIGS. 2A2B, which is consistent with the standard GeneXpert sample cartridge currently on the market. In this design, the cartridge body is separately formed from the base and the syringe tube is a separate tube that is inserted into the cartridge body before the base is attached to the cartridge body. The bottom of the syringe tube is attached to the valve body, which is relatively flat and is sealed by a flat gasket on the bottom of the cartridge body. The PCR tube is slid into the cartridge flange during initial assembly and secured by an additional component and attachment of the cartridge base. Accordingly, once the PCR tube is attached during initial assembly, it cannot easily be removed without disassembling the entire cartridge. This problem can be overcome in an alternative embodiment where the cartridge is designed to allow post-assembly attachment of the reaction tube.. This is advantageous when attaching specialized reaction tubes, which may incorporate costly materials, componentry or devices. After all the cartridge components are assembled, which can include components with pre-supplied reagents and/or processing agents, the cartridge lid (not shown) is attached by ultrasonic welding. While effective in sealing a polymer lid to the polymer cartridge body, the ultrasonic vibrations can potentially compromise interfaces between other components and/or inadvertently loosen or release reagents or processing agents provided in the cartridge. Thus, the design approach of conventional cartridges has certain drawbacks and may inhibit the ability to modify and/or include additional features. Accordingly, the improved design features not only simplify and improve manufacturing, assembly and operation of the sample cartridge, but are amenable to including various other features with the sample cartridge (e.g. alternative reaction vessels, pre-supplied reagents in solid or liquid form, etc.).

### B. Cartridge Components

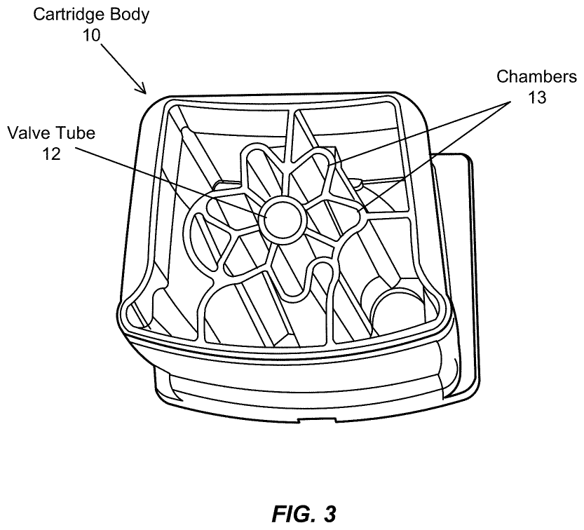

FIG. 3 shows a unitary cartridge body 10 having an integrally formed syringe tube 12 surrounded by multiple chambers 13. In this embodiment, the multiple chambers are formed in a petal-like arrangement around the central syringe tube 12. As compared to conventional cartridges that rely on a separate syringe tube inserted through a barrel, the integral syringe tube 12 is formed with a smaller diameter, for example a diameter within a range of 0.5 mm to about 5.0 mm, preferably about 3-4 mm. so as to allow substantially the same pressurization levels and control scheme by the module as that used with conventional cartridges. This not only simplifies the cartridge and its assembly, but this feature allows the size of the multiple chambers to be increased, for example a capacity between 3.0 mL and 7.5 mL, preferably about 5.0 mL, so that the cartridge has increased capacity as compared to conventional cartridges.

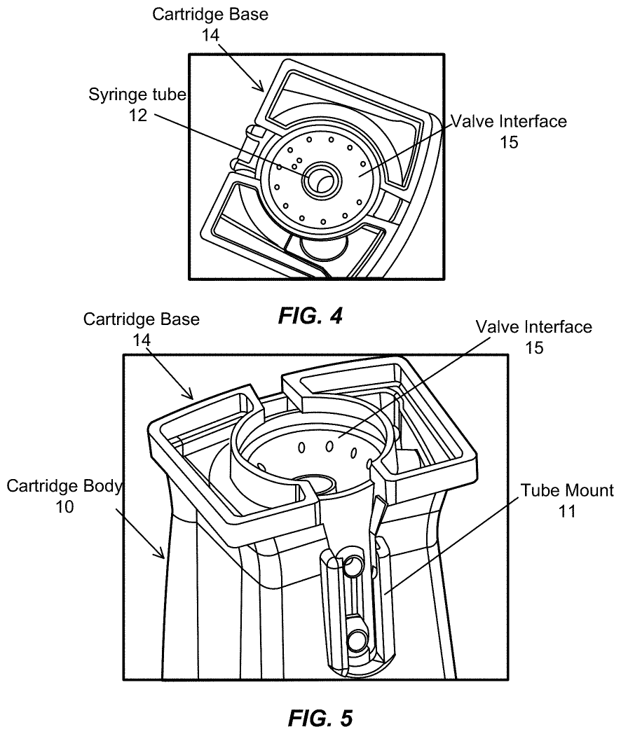

FIGS. 4-5 show underside views of the base 14 of the unitary cartridge body 10. As can be seen, the cartridge body 10 includes a valve interface 15 defined as a negative conical surface having multiple openings corresponding to the multiple chambers of the cartridge body. The bottom end of the integral syringe tube 12 extends beyond the surface of the valve interface, so as to extend into the valve body when mounted against the valve interface 15. As described previously, the cartridge body 10 and base 14 are designed so that the valve assembly can be inserted into the cartridge so as to engage the valve interface 15 and syringe tube without disassembling the cartridge.

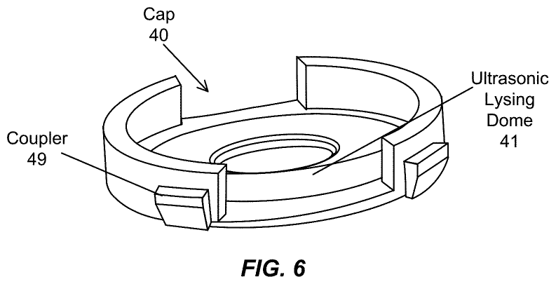

FIGS. 6-8 show the components of the valve assembly. It is noted that these components are shown upside-down (as shown in FIG. 1C) as compared to their orientation when assembled with the cartridge while the cartridge is sitting in an upright position.

FIG. 6 shows cap 40 of the valve assembly. Cap 40 is configured to securely couple to the valve body 20 by engagement of snap-fit couplers 49 that engage corresponding coupling features on the valve body. In this embodiment, the couplers 49 are wedge shaped features that resiliently deflect the corresponding coupling features of the valve body so as to securely snap the cap to the valve body. It is appreciated that various other coupling features could be used. The cap, along with the valve body, forms a filter chamber in which the biological sample is filtered. In this embodiment the cap includes an ultrasonic lysing dome 41 that is configured to engage with an ultrasonic horn so as to transmit ultrasonic energy into the filter chamber and lyse target DNA from particles filtered from the biological sample. It is appreciated that the lysing dome could be omitted, particularly in cartridges relying on other means for lysing to releasing nucleic acids from the biological sample.

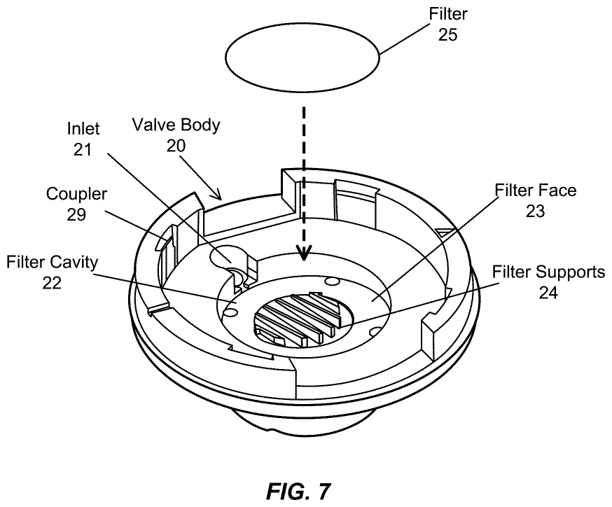

FIG. 7 shows an exemplary valve body 20 that is configured to securely attached to cap 40 by the corresponding coupling features 29 so as to form the filter cavity 22. The inlet 21 facilitates flow of fluid sample into the filter cavity 22 along filter face 23. The filter cavity 22 includes multiple filter support ribs 24 that support the filter membrane 25 above the filter face, so that the fluid sample flows through the filter, trapping targeted particles from the fluid sample. In this embodiment, the filter face 23 is angled relative a level plane (e.g. between 1 and 40 degrees, between 5 and 35 degrees) so as to slow the flow of fluid sample so that the fluid sample spreads more uniformly across the filter face and filter. This provides improved filtering performance as compared to conventional cartridges utilizing level filter planes and relying on horizontal flow. In this embodiment, the valve body 20 is further shaped to receive an overmold of the gasket (including four flow holes), described below.

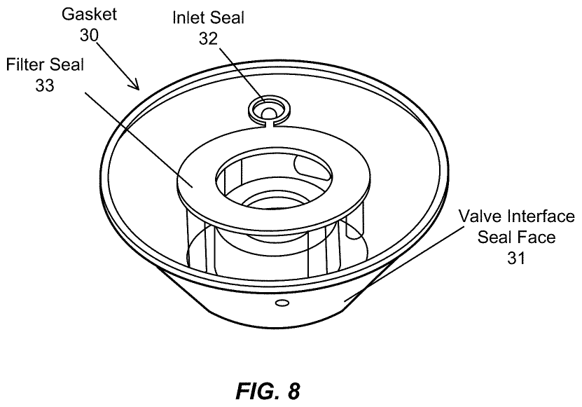

FIG. 8 depicts an overmolded gasket 30 configured to be integrated within the valve assembly. In this embodiment, the gasket 30 is designed to be overmolded (e.g. injected/molded within) onto the valve body 20. The valve has a protruding shape seal face 31 that engages against the valve interface of the cartridge body 10. In this embodiment, the seal face 31 is conical, although it is appreciated that it could be various other shapes, including convex or multi-angled shapes. It is advantageous for the seal surface to project upwards into the cartridge body (as opposed to being flat as in conventional cartridges) as this allows the gasket itself to generate higher axial forces within the gasket material (e.g. elastomer), without having to apply axial force on the valve body, which means less pressure required to rotate the valve and the gasket can provide enhanced sealing, as compared to conventional flat gaskets. As shown, the gasket further extends (by the overmold process) inside the valve assembly to form a filter seal ring 33 around the filter chamber and to form an inlet seal 32 around the inlet into the filter chamber. These seal rings seal the fluid flow into the fluid chamber and around the filter chamber to ensure the injected fluid sample passes through the filter.

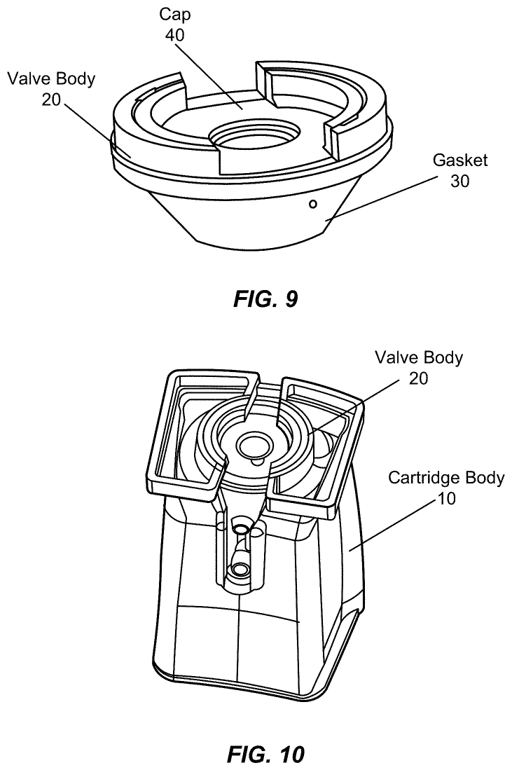

FIG. 9 shows the valve assembly including the valve body 20 with overmolded gasket 30 and cap 40 secured on the bottom, thereby defining the filter chamber within. This valve assembly can simply be inserted into the cartridge body 10 from an underside thereof, as shown in FIG. 10, and can be secured by a snap-fit interface to the cartridge body 10. The valve assembly can be held in place within the cartridge by corresponding snap-fit features, or any suitable means.

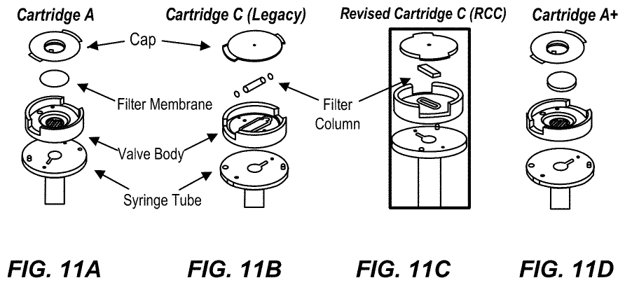

FIGS. 11A-11D show various alternative valve bodies suited for differing types of analytical testing that require differing types of lysing. For example, bacterial target may necessitate a valve assembly configured for ultrasonic lysing, such as in FIG. 11A and 11D, while viral targets may utilize chemical lysing and a glass filter column for affinity capture, as shown in FIG. 11B-11C, which may not require as robust a cap since ultrasonic energy is not applied.

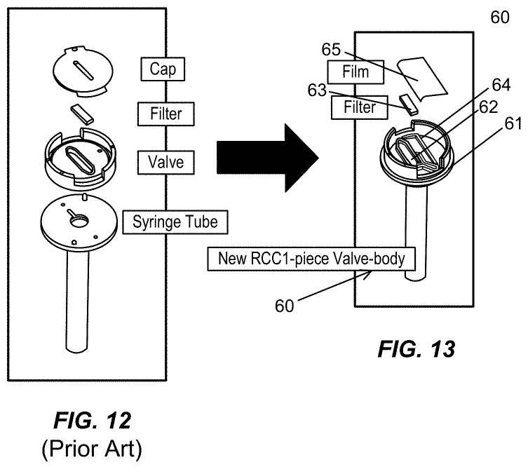

Although these designs show valve bodies that are relatively flat and are attached to a separate syringe tube, it is appreciated that the improved valve body described previously can be designed to accommodate either approach (e.g. ultrasonic lysing, chemical lysing). For example, the valve body 20 in FIG. 7 is configured for ultrasonic lysing, however, it could alternatively include a filter chamber compatible with chemical lysing, such as in FIGS. 11B-C, or in accordance with valve body designs in FIGS. 12-13. Such valve bodies could utilize overmolded gaskets and conical designs such as those described above.

### C. Alternative Components/Features

### 1. Unitary Valve Body for Chemical Lysis

FIGS. 12-13 show a highly simplified version of a valve body with a glass filter and configured for chemical lysing (such as in FIG. 11C). This design can drop the cost of the assembly to maybe ⅕ of the conventional design, simply by virtue of eliminating molded parts and simplifying tooling. One advantage is that the design does not require any side action in the tooling and combines the current three separately molded parts into a single simple part that is sealed with a film seal. As shown in FIG. 12, a conventional valve body for chemical lysis for viral targets includes three parts, a syringe tube, a valve body that is mounted on a separate syringe tube, and a cap. The valve body has a recess for receiving a glass filter. In the improved, simplified design of FIG. 13, the valve body and syringe tube can be formed as a single integrally formed component 60, such as by injection molding. Given the limitation of injection molding (e.g. typically requiring consistent thickness of material), the filter cavity can be defined by multiple walls 64 protruding from the inside face of the valve body 61. The multiple walls can define a flowpath as well as a filter chamber 62 in which the filter 63 resides. Rather than a cap, a thin film 65 is applied and sealed against the distal edges of the multiple walls thereby sealing the flowpath/filter chamber within. Since this type of valve body utilizes chemical lysis, rather than ultrasonic lysing, a thin film is sufficient to seal the filter chamber. The thin film may be formed of any suitable material, typically a chemical-resistant material (at least resistant to the lysing chemicals). This approach provides a simplified approach as compared to conventional designs. Further, it is appreciated that this same approach can be used to form a valve body without an integral syringe tube, for example, when used with a unitary cartridge body, as described previously. It is appreciated that in other embodiments, a cap could be used, rather than a thin film, more similar to conventional designs.

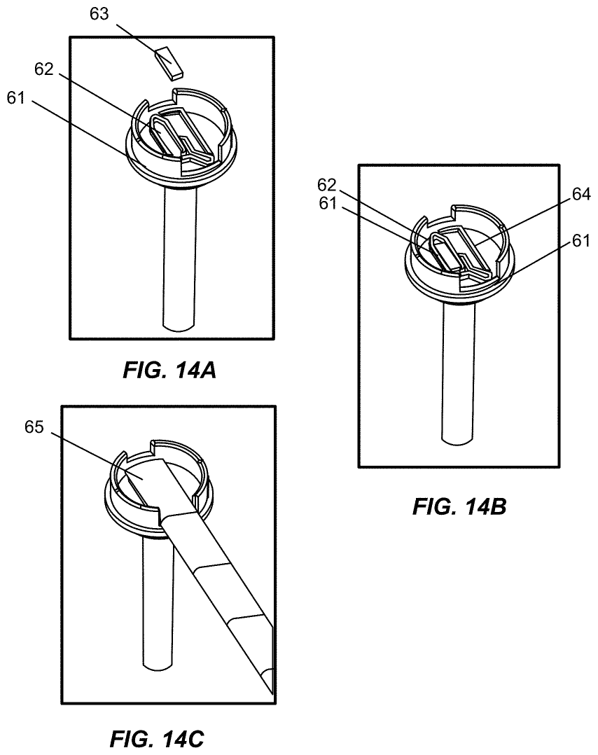

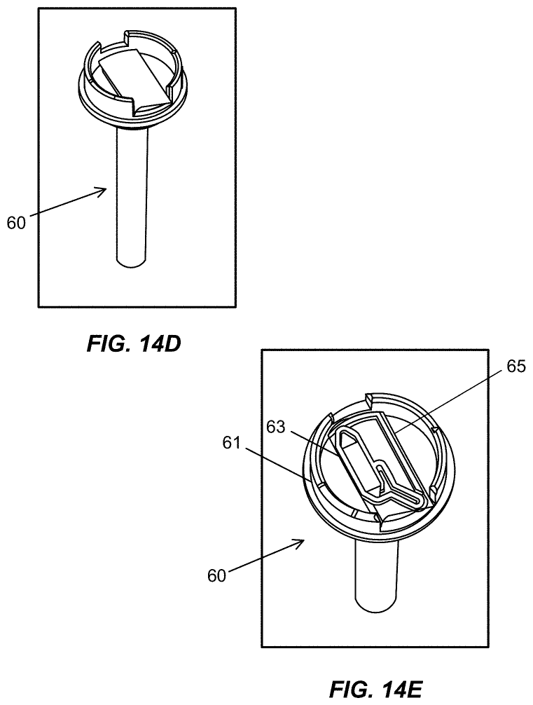

FIGS. 14A-14E depict the method of forming the integral valve body in FIG. 13. In FIG. 14A, a filter 63 is provided that is precisely laser cut to be placed within the filter chamber 62 defined by the walls 64 of the integral valve body 61. As shown in FIG. 14B, the filter is fittingly received within the filter chamber 62 of the integral valve body 61. As shown in FIG. 14C, the thin film 65 is placed over the walls 64 of the valve body 61. As shown in FIG. 14D, the thin film is then laser cut/tacked and heat sealed. As shown in FIG. 14E, the thin film has fluidically sealed the flowpath/filter chamber so that inflow of fluid sample is forced through the filter 63 where particles released by chemical lysis can be retained for subsequent elution and analysis.

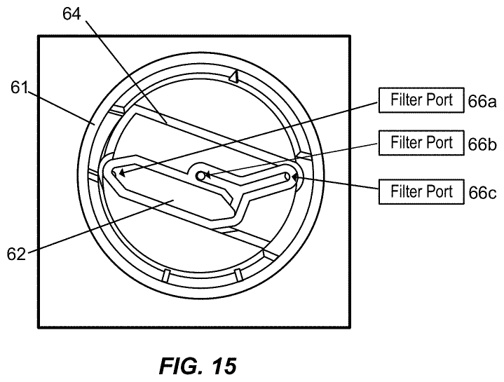

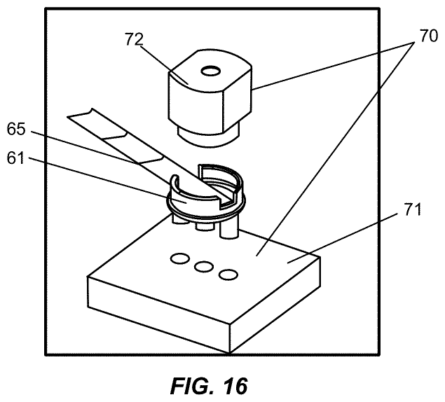

FIG. 15 depicts an exemplary valve body for chemical lysis illustrating the filter ports 66a,66b,66c that facilitate inflow of fluid sample into the valve body and into the filter chamber 62 as well as fluid flow out of the filter chamber through filter port 66c. Port 66b is the port associated with the syringe, port 66a provides a thru filter path through the glass filter placed in the chamber 62, and filter 66c provides a direct path from the syringe that bypasses the filter.

FIG. 16 shows an exemplary tool for heat-sealing the thin film to the walls on the inner face of the valve body 61. The base 71 supports the valve body 61. In this embodiment, the base includes three openings that receive stubs that feed the filter ports. A heat sealer component 72 holds down the thin film material independently of the heat seal head so that the seal joint has a chance to cool before being subjected to the force of the filter material rebounding, for example an acrylic filter can be compressed and push back when released. It is appreciated that this is but one example and that various other tools for heat sealing the thin film could be realized.

In another aspect, the improved sample cartridge design could include variations of the tube mount on the unitary cartridge body described previously. The tube mount can be formed in the unitary body such that no other component other than the cartridge body and reaction vessel are needed to sealingly couple the reaction vessel to the sample cartridge. Such a design simplifies tooling, reduces plastic, reduces leak possibility, reduces the amount of material needed and can allow for faster molding cycling times, lower cost and maintenance.

### 2. “No-Loop” Concept

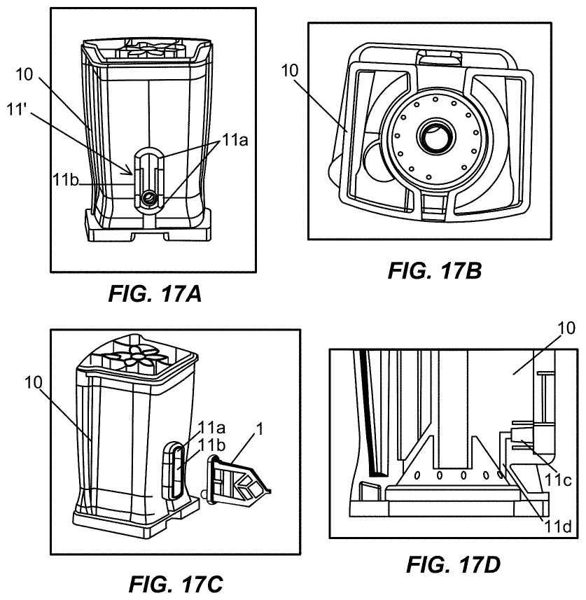

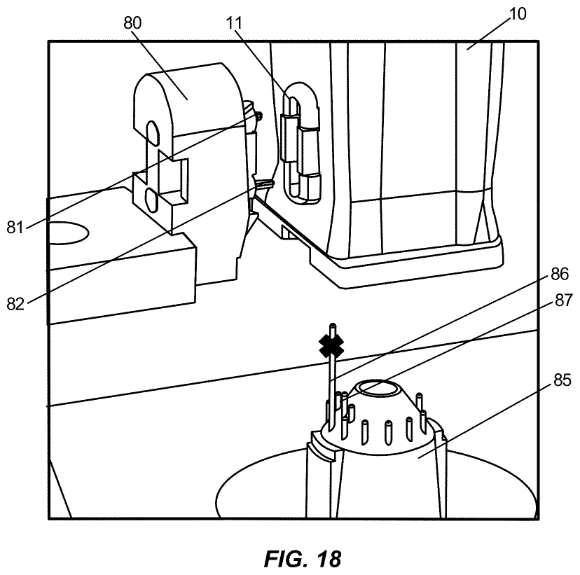

FIGS. 17A-17D illlustrate a “no-loop concept” where only one fluid port of the two-channel reaction vessel is fluidically coupled to the chambers of the cartridge. In this embodiment, the mount includes a snap-fit interface for sealingly coupling the cartridge with a specialized reaction vessel having a single fluidic port/stub extending from the lower fluid channel while the upper fluid port is open to atmosphere (hence, no need to fluidically couple to the cartridge). FIG. 17A shows a unitary cartridge body 10 having a tube mount 11′ with a single fluidic port 11c, and upper/lower ridges 11a, 11b and a snap-fit interface 11b that resilient snaps onto the proximal flange of the fluidic interface of the reaction vessel to securely couple the reaction vessel to the cartridge. As can be seen in FIG. 17D, the cartridge is fluidically coupled through the lower fluid port 11c connected to vertical channel lld that fluidically couples to the valve assembly so that operation of the cartridge controls inflow/outflow of elusion into the reaction vessel through the single port/channel.

In a conventional two-channel reaction vessel with two fluidic ports both fluidically coupled to the sample cartridge, the flow path of the reaction vessel forms a closed loop such that fluid flow within the reaction vessel is controlled by controlling pressure through both fluidic ports. In this alternative approach, the reaction vessel has a “no-loop” design where one channel (e.g. bottom channel) is fluidically coupled to the sample cartridge while the other channel (e.g. top channel) is closed to atmosphere. In some embodiments, the channel is open to atmosphere through a stop or fit, which is a hydrophobic element that passes air but not liquid, not having to route back through a crossover and thus simplifying the cartridge. Not only is this design simplified and require less material, but there are significant tooling advantages associated with this design. Additionally, this eliminates the possibility of improperly attaching the reaction vessel upside-down.

In still another alternative design, the “no-loop” tube can be dead-headed, with one channel being closed (rather than open to atmosphere) which basically pressurizes the dead head. In some embodiments, the system is designed so that the channel deadheads in the cartridge. In still other embodiments, the reaction vessel can be designed to avoid dead heading in the cartridge, but rather to dead head in the reaction vessel itself. This eliminates the need to seal one port, as well as the need for an upper port on the cartridge. One issue with a dead headed reaction tube is the pressure ratio between the empty tube (ET) (sum of the top channel, reaction chamber, bottom channel, bottom channel on cartridge to the sealing surface) and the filled tube (FT) (sum of reaction chamber, bottom channel, bottom channel on cartridge to the sealing surface), where pressure ratio would be ET/(ET-FT). This number ×1 Atmosphere (e.g. 15 PSI) is the pressure in the reaction tube chamber, which will be higher with higher volume reaction tubes. So, in such embodiments, if the pressure ratio were 10:1, then the tube pressure would be 10 atm or about 150 PSI. This approach assumes that sufficient pressure can be maintained in the reaction tubes and cartridges (e.g. about 150 PSI).

In cartridge designs that cannot maintain sufficient pressure, this drawback can be mitigated by pulling negative pressure on the reaction tube before filling. By this approach, in the case of a 10:1 pressure ratio, if a negative pressure at around 1/9 atmosphere was pulled, the end result would be around 15 PSI of tube pressure. Another challenge with this approach is that it may be more difficult to evacuate all of the fluid from the reaction chamber as pressures turn negative as the tube is emptied. However, by further increasing headspace volume (e.g. increasing chamber size or adding flowpath), pressure ratios can be reduced so that the fluid can be sufficiently evacuated in accordance with the desired workflow.

In one aspect, this “no-loop” tube approach can be readily implemented by minor modifications to existing tools used to from conventional reaction tubes and cartridges. As shown in FIG. 18, tool 80 has upper/lower pins 81,82 that are used to form the upper and lower ports in the conventional reaction tube. This can be readily modified by replacing the upper pin 81 with a blanking or broken pin so that advancement of the tool forms only a single port (the upper cross-over port having been eliminated). Similarly, tool 85 uses multiple pins to form the internal channels within the cartridge body to fluidically couple the multiple chambers, pins 86,87 forming the channels that connect the ports to the valve assembly in a conventional design. To form this new design, the longer crossover pin 86 that couples the top port can be eliminated. Accordingly, this modification means that the cartridge no longer has or needs an “inner track” for sealing.

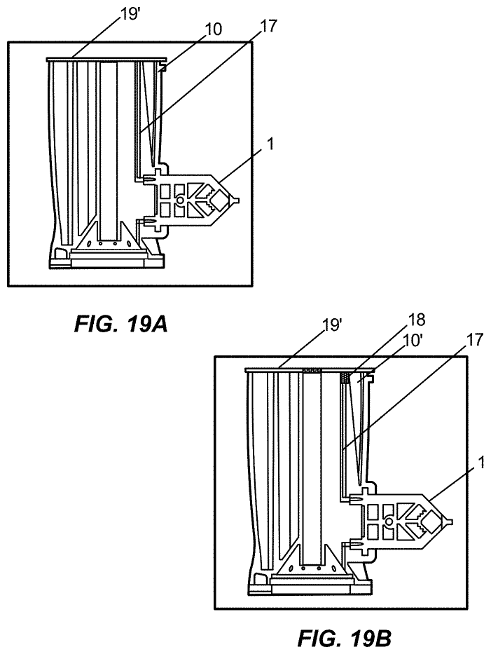

While the unitary cartridge design is shown and described above, it is appreciated that this same concept and operation can be performed on a conventional sample cartridge, such as that shown in FIG. 2A. These “no-loop” tube concepts present enough significant advantage that they would provide these same advantages in the conventional cartridge design or similar design. This also holds true for a film sealed cartridge model, where a frit would not be needed and a reliable top seal with an effective dead head volume could be achieved with a rather small perimeter seal, or a frit could be added to a port in the top seal. These latter aspects are shown in FIGS. 19A-19B, which each show film sealed cartridges 10, each having a thin film seal lid 19′ atop the cartridge that seals the multiple chambers. One or more ports can be provided through the film seal to allow introduction of the fluid sample, or optionally additional reagents. FIG. 19A shows a cartridge having upper/lower ports for receiving a two-port reaction vessel. The upper fluid port in the cartridge is coupled to a channel 17 that provides sufficient headspace to utilize the “no-loop” concept as described above. FIG. 19B shows a cartridge in which the upper channel 17 is open to atmosphere through a frit 18 in order to utilize the “no-loop concept.” In this embodiment, the frit could be located anywhere vertically and the film seal vented to atmosphere. In some embodiments, the cartridge includes only a thin film lid, while in other embodiments, the cartridge can include an overlay lid in addition to the thin film lid.

### 3. Thin Film Cartridge Lid Sealing

In another aspect, the unitary cartridge can utilize an improved approach to sealing a top lid component atop the cartridge. While this approach is described with respect to the unitary cartridge with integrated lid, it is appreciated that aspects of this film sealing approach can apply to separate lids on any cartridge, including the conventional cartridge in FIG. 2A.

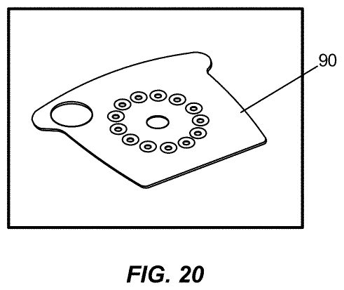

In some embodiments the lid is integrally molded with the cartridge body and the lid is attached to the cartridge body by film sealing, rather than ultrasonic welding as used in conventional cartridge. The use of film sealing reduces damage to cartridge components and reducing costs, including possibly reducing the volume of plastic in the cartridge significantly. In this approach a thin-film insert is prepared to seal atop the cartridge between the lid and the cartridge. As shown in FIG. 20, the thin film insert 90 can be precisely shaped (e.g. by laser cutting) to correspond to the shape of the top of the cartridge and can optionally include specially cut vent holes or annular rings to form openings for the chambers below for filling. Various different methods known to the skilled artisan can be used to seal the cartridge, including but not limited to adhesives, heat sealing and induction welding.

### 4. Magnetic Separation

In yet another aspect, the cartridge can include feature to provide for magnetic separation. The basic principle behind magnetic separation is that a magnetic particle is attached to a probe that will bind to a target specific to a molecule/target to isolate. This includes not only intact cells or organisms, but also DNA, RNA, and protein targets. This magnetic conjugate is then introduced to the sample pool containing the target. Generally, this is done in a liquid, where the kinetics are quite favorable. Once attached to the target, a magnet or magnetic field can be used to capture and hold the magnetically tagged target, and the non-target can be washed away, or undergo further steps if the purpose of the magnetic capture was to remove unwanted elements from the sample (depletion mode). If the molecule of interest is the magnetically tagged target, the magnetic capture can hold the target and endure rather robust rinsing/washing steps in addition to exposure to reagents and chemistry in situ. Then, (in most commercially available products) the target can be eluted by simply removing the magnet or magnetic field. There are also chemistry methods of de-coupling the ligand from the iron particle.

In the case of the magnetic separation in a sample cartridge, such as those described herein, the method of release will most likely be achieved by using the sonication horn to release the target. A ‘removal of the magnetic field’ proposal will be described as well. There are two basic release models, the “impact” model and the “bond-breaking” model.

In the impact model, the magnetic particle(s) are tied to a cell/bacteria/spore and then bound to the magnetic field. The actual target lies in the contents of the cell, and are accessed by using the ultrasonic horn to break the cell, releasing its contents.

In the bond-breaking model, the magnetic particles are tied to the target molecule(s) and bound to the magnetic field. The targets are released by mechanically breaking the ties to the magnetic particle using ultrasonic energy. There are also chemical methods known to persons of skill in the art that can do this.

It is appreciated that while these embodiments depict a valve assembly with a conventional syringe tube, these concepts can be incorporated into the improved valve assemblies described herein, including the unitary cartridge body.

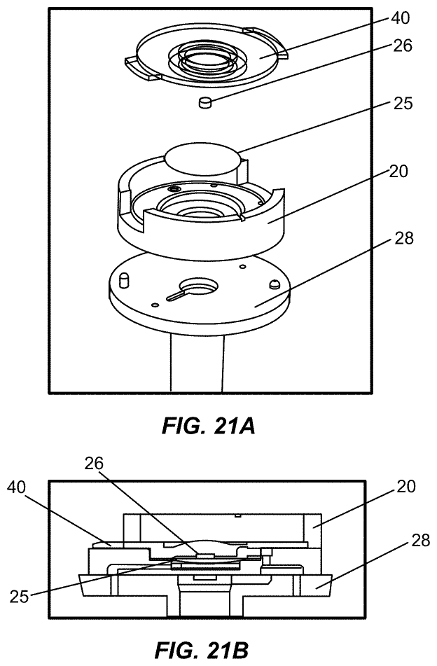

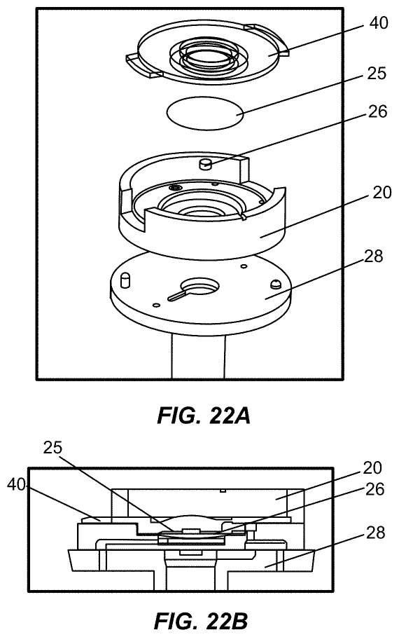

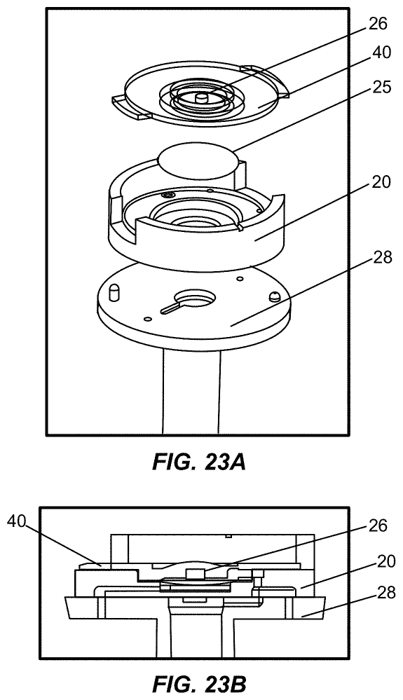

In the embodiment of FIGS. 21A-21B, a magnet 26 is attached in the valve body assembly between the filter 25 and the cap 40, as shown. The magnet may be welded or attached by any suitable means. The cap may include a pocket to provide clearance for the magnet. In the embodiments of FIGS. 22A-22B, the magnet is attached in the valve body assembly on the other side of the filter between the filter and the valve body, as shown. The magnet may be welded or attached by any suitable means, and the valve body may be modified to include a pocket (e.g. between filter support) for the magnet. In the embodiments of FIGS. 23A-23B, the magnet is attached in the valve body assembly within the cap. The magnet may be welded or attached by any suitable means, including being insert-molded into the cap. The cap may be modified in shape to provide clearance for the magnet.

In some embodiments, software commands to direct fluid manipulations to perform each of the above methods involving pumping the magnetic conjugate from one of the inner chambers into the sample chamber and gently agitating the solution can be included. This could also occur in a separate fresh chamber if the sample type requires it (e.g. post pre-filter). The mixture is then passed through the filter chamber, where the target is bound to the magnet directly (e.g. in the case of the first and second configuration) or to the filter surface adjacent the magnet (e.g. third configuration). Wash steps can then be performed, including reversing the flow off of the filter. Then to obtain the target, sonication is applied and an elution is performed.

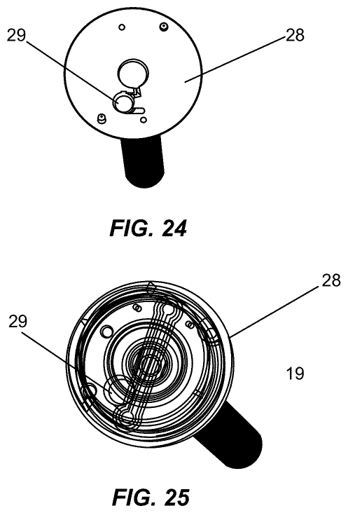

In another aspect, the valve interface can include a magnetic capture chamber that would allow release of the magnetic field to provide the capability of more powerful sample preparations and purifications using magnetic separation. In some embodiments, a direct port channel on syringe tube is modified to create a magnetic capture chamber, as shown in FIGS. 24-25. The valve body component can also be modified with associated energy directors and supports so that the capture chamber is properly contained.

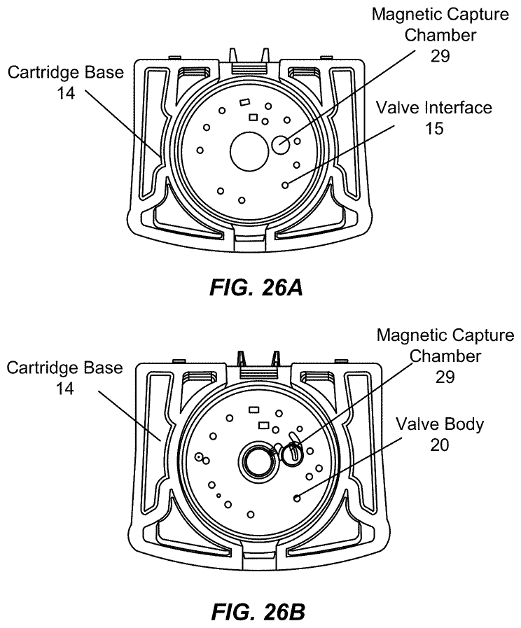

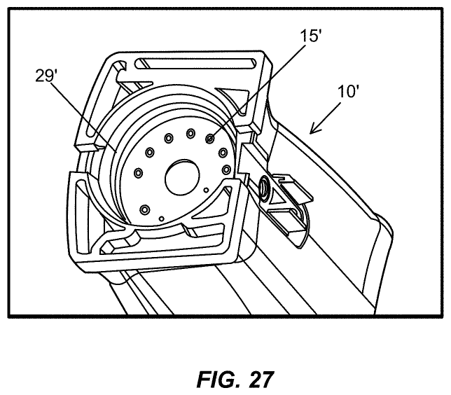

While these features are shown in regard to a valve body interface attached to a separate syringe tube it is appreciated that these concepts could readily be applied to the valve interface of the unitary cartridge body as described herein, for example, as shown in FIGS. 26A-26B. In these embodiments, the magnet is insert molded into the cartridge body in the desired position. This is fairly simple since the magnet will hold itself onto the tool. A shallow pocket can be burned into the B side steel for consistent location of the magnet. The over-mold will then cover the magnet, so it will never be subjected to contact with liquids. The location of the magnet is designed so that when the valve body is dispensing to waste on the direct port. In this embodiment, the magnet is positioned directly adjacent the magnetic capture chamber.

### III. Cartridge Design Iterations

### A. Overview

While the above feature have been discussed as potential features of a sample cartridge, it is appreciated that a given sample cartridge could include any single feature or any combination of these features, as well as various other additional features discussed further below. There may be reason to include only certain combinations of features, which can include compatibility with existing modules, protocols or reaction vessels, minimizing changes in manufacturing or assembly workflow, availability of materials or manufacturing tools, or various other reasons. Further, given the breadth of modification and additional features, it may be advantageous to implement these features in design iterations to minimize the impact of changes in the manufacturing workflow as well as any compatibility issues with existing devices or methods, or simply to try differing approaches to gauge their success. The following table represents iterative designs having select features incorporated herein for at least some of the reasons discussed above. It is appreciated that various other designs could be realized departing from the matrix shown. Aspects of each feature are summarized/discussed further below.

TABLE 1
Matrix of Features of Cartridge Design Iterations

| | Design | Design | Design |
|---|---|---|---|
| | 1.0 | 1.5 | 2.0 |
| Compatible with production Valve Body | X | X | |
| Compatible with Conventional Reaction | X | X | X |
| Tube | | | |
| Gasket-less tube ports | X | X | X |
| Snap-in Tube | X | X | X |
| Snap in Valve Body | X | X | X |
| Integrated Foot | X | X | X |
| Annular Valve body snap feature (e.g. 6 | X | X | |
| blade Collpasing core) | | | |
| Semi Annular Valve body snap (e.g. 2 | | | X |
| slides) | | | |
| Tube Snap formed by A side Motion | X | | |
| Tube Snap formed by collapsing core | | X | X |
| Front Face formed by slide & collapsing | X | | |
| fingers | | | |
| Front Face formed by single slide | | X | X |
| Integrated syringe bore | | | X |
| Comical valve sealing surface | | | X |
| Gated near top of cartridge body | X | | |
| Gated near bottom of cartridge body | | X | X |
| Possible integrated Lid in tooling | | | X |

With this arrangement, a highly simplified, typical software protocol for magnetic capture and purification can be realized. In one example, this simplified protocol can include the following steps: 1.) Aspirate buffer, direct path (“D”), dispense to waste to prime the valve-body and chambers, filter path (“F”). 2.) Aspirate from magnetic bead reagent chamber D, dispense to sample chamber, D. 3.) Toggle, D, sample chamber. 4.) Big Aspirate, D, Sample. 5.) Slow Dispense, D, to waste, the capture chamber is active on this step. 6.) Small Aspirate, D, from buffer (picking off mag beads because magnet is not in position). 7.) Fast Dispense, D, to target chamber. 8.) Repeat steps 4 through 7 until desired total amount of Sample is processed. 9.) Optional concentrator step, Large aspirate (all of) from target chamber, Slow dispense to waste, D. 10.) Aspirate from buffer or other reagent, D, Dispense optionally to PCR beads chamber. This step concentrates the target in buffer of choice and then sends to mix with PCR reagents, skipping the filter, if desired, or the mix could be sent to the filter, lysed and processed on the next step. In some embodiments, magnetic purification can operate independently of the filter if desired. Such protocols can be utilized in a variety of applications, including but not limited to: WBC depletion or enrichment for HIV quant assay; target enrichment for methylation, cancer assays (plasma pool); bacteria isolation for sepsis; and protein purifications

### B. Cartridge Design Features

### 1. Compatibility with Conventional Valve Bodies/Reaction Vessels

In one aspect, the cartridge design is configured to be compatible with conventional valve bodies and/or compatible with conventional reaction vessel (i.e. reaction tube). It is advantageous for the first design iteration, Design 1.0, to be compatible with the other current production components, which includes the lid, reaction tube and valve body assembly. The cartridge ‘foot’ or base is compatible in the sense that it is integrated, so no longer is needed as a separate component.

### 2. Gasket-Less Tube Ports

In another aspect, the cartridge can be configured with gasket-less tube ports (i.e. fluid ports to the reaction vessel). In the current conventional cartridge design, the cartridge body is overmolded with a suitable material (e.g. TPV (Thermo Plastic Vulcanate)) that provides an elastic sealing interface for both the valve body sealing surface and the reaction tube ports. Eliminating the elastic from the tube port sealing surface simplifies the cartridge body molding tool, and greatly simplifies the overmolding tool by eliminating the requirement for side action in the overmolding tool.

### 3. Snap-In Tube

In yet another aspect, the cartridge design can be configured with a snap-in tube. The current conventional cartridge design requires both the valve body and the reaction tube to be placed on the cartridge body, and then the separate foot component is installed to retain both the reaction tube and the valve body. By designing the tube retention feature so that the reaction tube can be snapped in (e.g. by a snap-fit tube mount), the constraint in the order of assembly in the manufacturing line is removed. Removing this constraint allows for more manufacturing flexibility and ultimately will result in lower logistics costs and improve assembly design. Additionally, in the case of high value reaction tube designs, including next generation reaction vessel having diagnostic chips and/or on-board microarrays, the value of the reaction tube component can sometimes exceed the value of the assembled cartridge component. By allowing a different order of assembly, the aggregate component risk can be reduced, so that only tested good cartridge assemblies can be mated with tested good reaction tube assemblies, reducing sunken-cost impacts due to defects.

### 4. Snap-In Valve Body

In another aspect, the cartridge design can be configured with a snap-in valve body. The conventional cartridge design can utilize a valve assembly mounted to the separate syringe tube and requires assembly before attaching the separate cartridge base. In the unitary cartridge design, the combination of a snap-in tube design and snap-in valve design removes the need for a separate foot component, saving component and logistics and assembly costs. The valve assembly can be inserted from an underside of the integrally formed base and snapped into plate (e.g. by a snap-fit coupling). Additionally, a key benefit of the snap in valve body design is that the elimination of the separate foot component eliminates two mechanical tolerance stacks from the valve body assembly tolerance equation. This is the snap to valve face tolerance on the foot, and the snap window to gasket surface on the cartridge body. This can be advantageous, because with a relatively thin (e.g. 8 mm) total seal thickness and desired compression specification range (e.g. 0.2-0.4 mm), the stacked tolerances can eliminate the actual process window for an acceptable final assembly. Typically, the molded in snap produces only one dimension of interest, which is the top of the rubber seal to the lip of the snap. The design is devised so that the distance from the top surface of the snap feature to the snap lip is held constant being in the same piece of steel, therefore making the measurement of the gasket top to the snap lip greatly simplified. Accordingly, in-process controls can be implemented to hold a tight range on this dimension. This translates overall to much higher acceptable final assembly yield as well as a reduced or eliminated exclusion matrix, greatly reducing production yield losses and the costs associated with them.

### 5. Annular Valve Body Snap

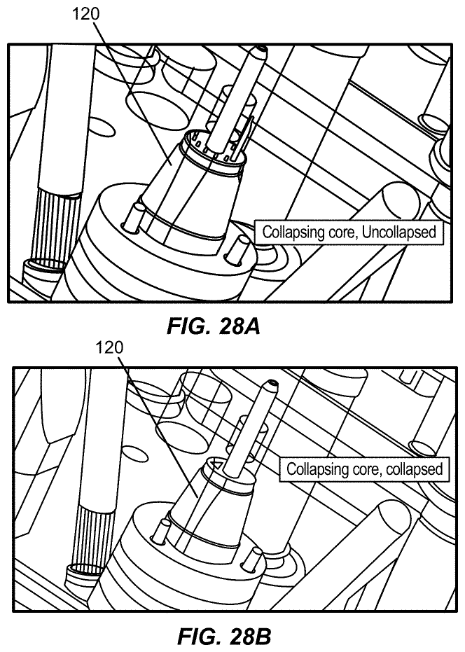

In another aspect, the cartridge design can include a valve body snap-in feature. In some embodiments, this snap-in feature can be made using a 6-blade collapsing core. This feature is included in Designs 1 and 1.5 This feature can utilize an ‘annular snap design’ 29′, as shown in FIG. 27. Although this feature is shown in a cartridge having a flat valve interface 15′, it is appreciated the same/similar feature can be used in other cartridge designs as well. This feature is achieved in the molding tooling using an element called a ‘collapsing core’ in the tool. Generally these components can be provided in using standard tool designs and tooling approaches. An exemplary tool with collapsing core is shown in FIGS. 28A-28B. In this embodiment, the tool includes a 6-blade collapsing core 120. The darker components are identical to each other, and the lighter shaded components are identical to each other. These 6 blades slide along a central core (vertical shaft) which makes the blades close down on each other as the core is retracted axially relative to the blades.

### 6. Integrated Foot

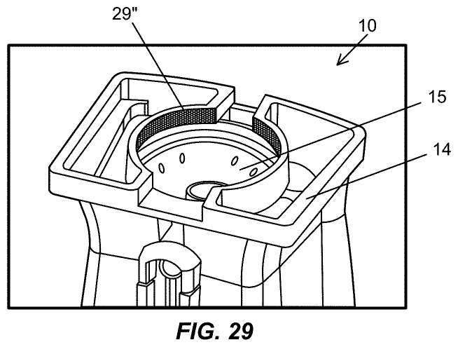

In still another aspect, the cartridge design can include a unitary cartridge body having an integrated ‘foot’ or base. This feature is shown in FIGS. 1A-1C as part of the unitary cartridge body and also in FIG. 29. The discussion above in regard to the snap in valve body and snap in tube show the key benefits of those two features. Those features eliminate the need for a separate foot component, which saves tooling, molding and assembly costs of that component, resulting in a design where the foot is integrated within the cartridge body. In addition to eliminating the separate base part, the integrated foot allows the total amount of plastic in the cartridge assembly to be greatly reduced, singe the redundant interface walls and features in the two separate parts is now reduced to a singular wall. This also increases the volumes available in the chambers and increases the steel to plastic ratio in the tooling, which both improves the product, and improves the part cycle time and tool life.

### 7. Semi Annular Valve Body Snap

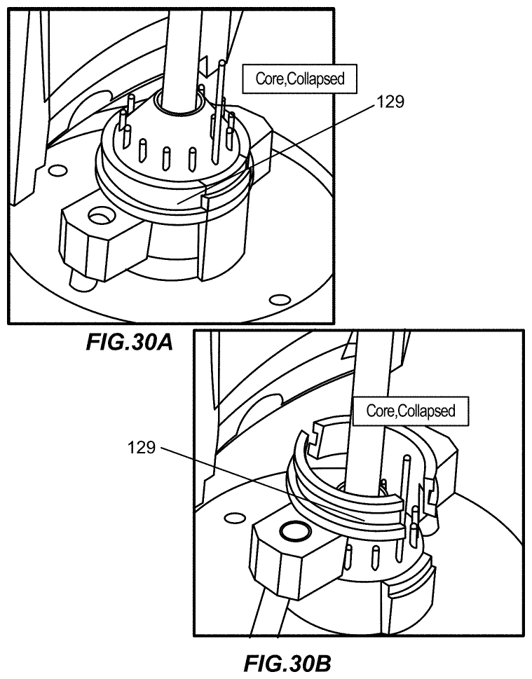

In another aspect, a semi-annular valve body snap feature can be used, as shown in FIG. 27. This snap-in feature 29″ is an alternative approach that is used in Design 2.0 which resolves some drawbacks of the 6-blade collapsing core. In this embodiment, the snap-in feature relies on two slides. Since the new design requires only two moving pieces, this is more robust than the conventional assembly. The new snap design, shown in FIG. 29 is compromised in some respects, because it is not a full annular snap, however this is more than compensated for by providing a stiffer snap structure, which also takes advantage of the stiffness of the conical valve body design. Additionally, there are manufacturing advantages as it this approach avoids damage to the cartridge body and the collapsing parts will not interfere with the pins on the core that form the chamber ports. The tooling used to create these features is simpler in design and potentially more robust. It also alleviates a risk to the molding tool operator and maintenance people because it does not feature the incredibly sharp blades found on the 6 Blade collapsing core. FIGS. 30A-30B show an exemplary tools 129 for forming this snap-in feature.

### 8. Tube Snap Formed by A Side Motion

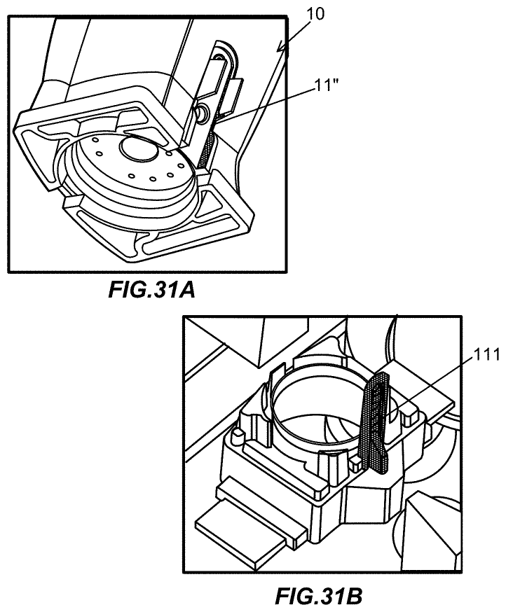

In yet another aspect, the cartridge can include a reaction vessel snap-in mount that is formed by an A side motion, as shown in FIGS. 31A-31B. This snap-in feature 11″ (darker portions indicated undercuts) is used on Design 1.0 and is formed in a similar way as the current conventional cartridge designs form these features, which is by use of a tool having a blade 111 on the A-Side of the tool, as shown in FIG. 31B. In the molded part, the snap does function fairly well however needs some modification to increase the stiffness of the feature. One potential drawback of the design is that it requires the tooling that forms the ports and channels for the reaction tube to move out of the way before the A side tooling can move out of the way. This in-turn, dictates how the shut-offs between the vertical and horizontal channels for the tube ports are configured, resulting thicker section vertical port pins to be stiff enough to work with a lateral shut-off. The consequence is additional fluidic volume required for tube filling.

### 9. Tube Snap Formed by Collapsing Core Tool

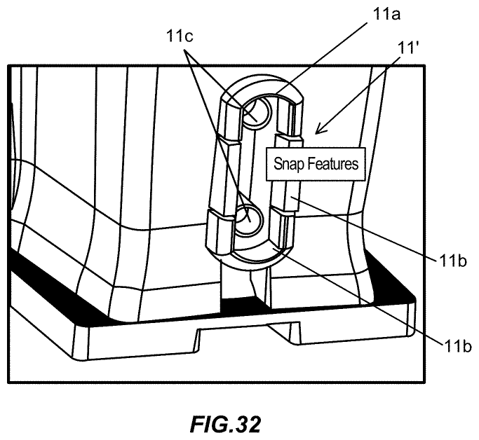

In still another aspect, the cartridge can include a tube snap-in feature formed by a collapsing core. FIG. 32 shows this an example of such a snap-in feature 11b. The design deficits in both the current conventional cartridge and Design 1.0 are addressed by snap-features that are formed (especially the undercuts) by a collapsing core design. The design allows for simple and robust components, and rectifies the issue of clearing the horizontal port tooling pins before moving the A side core. In this newer design, the A side can freely open with no interference, and therefore the shutoffs can be arranged so that vertical port tooling pins can shut off into the horizontal pins. This allows the vertical pins to be slender and share the same profile as the rest of the port pins for the chambers. The horizontal pins then provide sufficient stiffness for shutting off the slender vertical pins, which is not a problem since they are very short and therefore inherently relatively stiff. In this embodiment, a tube mount for dual ports 11c is shown, but it is appreciate that this tube mount design could be used for any tube mount, include a single port design.

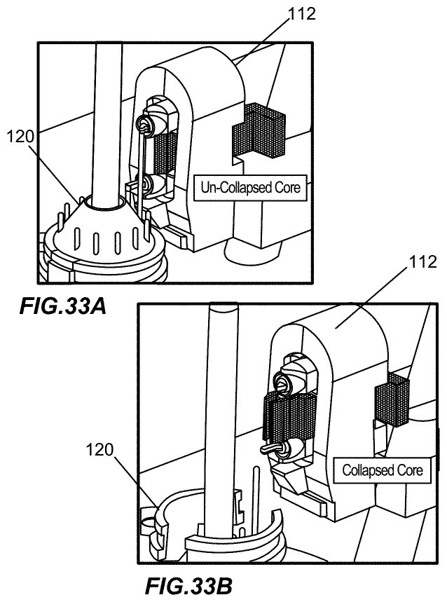

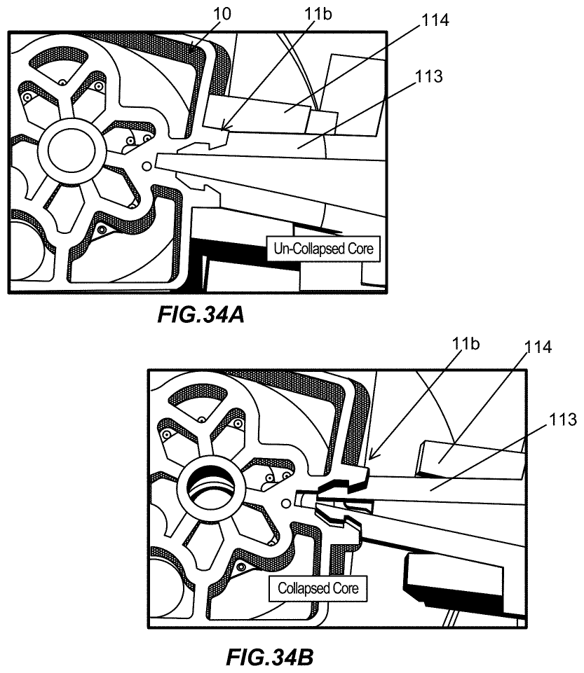

FIGS. 33A-33B show exemplary tools 112 having a collapsing core 113 for fabricating this snap-in feature is shown in FIG. 32. Detail view of the collapsing core portion are shown in FIGS. 34A-3B. The snap undercuts and top face are formed by the two slides. The main slide 114 forms the rest of the features. Note that the vertical pins shut off into the horizontal port pins. Accordingly, the fill volumes for the reaction tube should be significantly reduced, in addition to decreased tool maintenance due to the simple design of the pins.

### 10. Front Face Formed by Slide & Collapsing Fingers

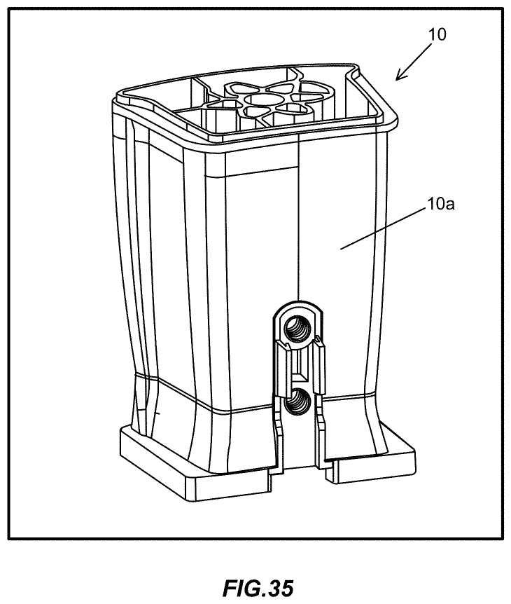

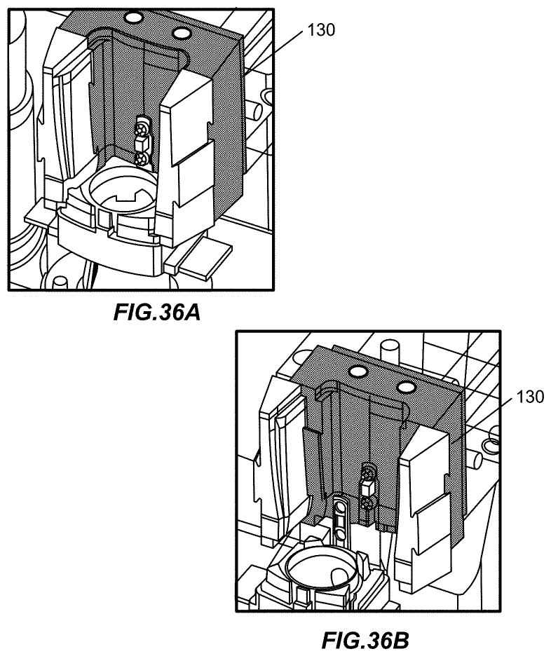

Another design feature is the front face of the cartridge body being formed by a tool having a slide and collapsing fingers. FIG. 35 shows front face 10a of the cartridge and FIGS. 36A-36B show the tool 130 for forming the front face. This can be used for Design 1.0 and advantageously, the tool can be built by modified an existing tool base. To modify the tool, the end portion of the slide can be designed to move outward as the slide moved away so that it clear the integrated foot as the tool opened. FIG. 36A shows the slide in the molding position and the fingers are closed, and FIG. 36B shows the fingers opened when the tool is opened. The allows the B side core with the part to clear the A side tooling, specifically the sides of the foot flanges.

### 11. Front Face Formed by Single Slide

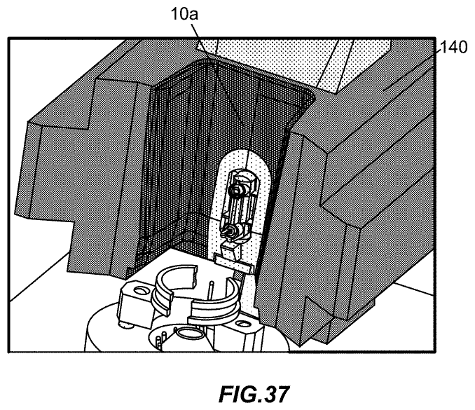

FIG. 37 shows another tool 140 configured to form the front face is formed by a single slide. Designs 1.5 and 2.0 use this feature which avoids the constraints of an existing tool base. Advantageously, the slide that forms the front face in this tool can remain as one piece, since sufficient slide action can be designed in in order to clear the foot flange when the tool opens. This slide will also contain the sub-slide action that will provide the collapsing core for the tube snap.

### 12. Integrated Syringe Bore

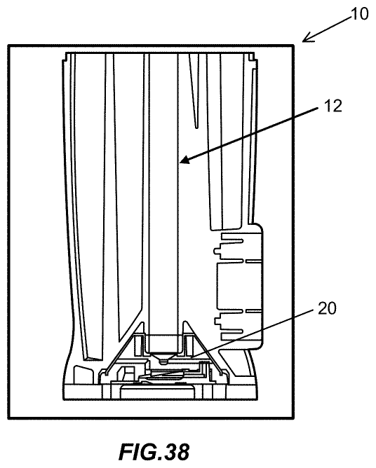

Another aspect, described previously, is the integrated syringe bore, which obviates the need for a separate syringe tube inserted through a syringe barrel. A cross-sectional side view of this feature is shown in FIG. 38. Design 2.0 design uses this feature. This can dramatically reducing the size of the valve body component allowing for easier manufacturing and part handling, and faster cycle times on the valve body tool. Another benefit is that the cartridge body can be molded from other types of plastics such as PolyPropylene (PP) or High Density PolyEthylene (HDPE). This change also avoids the expensive and troublesome step of lubricating the plungers with specialized grease, and allows simple lubrication with silicone oil. This feature further improves cartridge performance and chemical compatibility and yield while lowering component costs. An additional benefit of this feature is additional available volume in the cartridge for sample and reagents, and a reduction of the total amount of plastic in the cartridge assembly.

### 13. Conical Valve

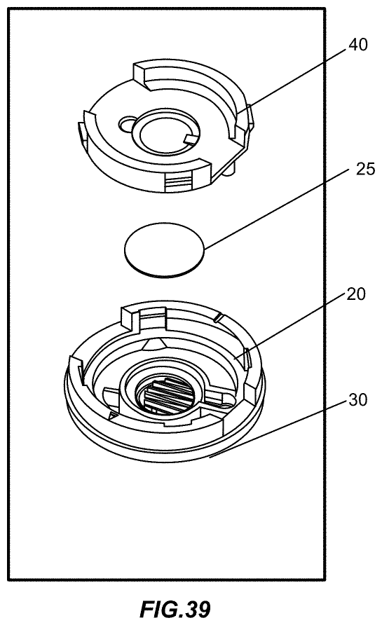

Another feature, described previously, is the conical valve assembly, as shown in FIG. 39. This conical shaped gasket 30 of the valve assembly stands in stark contrast to conventional designs that are relatively flat along the cartridge interface. Design 2.0, which avoids being restricted to the production valve body assemblies, thus can take advantage of this new conical valve. The conical design of the valve sealing surface has the advantage of being able to generate gasket compression forces with a radial component ad well as an axial component. This greatly diminishes the axial force required that is transmitted through the valve flange and snap feature for a given gasket compression force required, resulting in lower torque requirements for turning the valve. Another benefit is that the conical design allows the complete formation of the channels inside of the valve body using simple side action slides. This eliminates the requirement of two parts (syringe tube and valve body) to be assembled to form these features, which results in the elimination of one of the valve body components and significantly the assembly step of ultrasonic welding.

In one aspect, the overmolding of seals/gaskets is simplified by use of this valve assembly. The valve is also designed so that the rubber overmolding process is removed from the cartridge body and moved to the much easier to handle valve body, which results in significantly improved cycle times. The rubber of the gasket is then also used to provide a sealing ring for the filter cavity. In another aspect, the valve assembly can use a snap-on cap. In this embodiment, the valve is design with undercut features in the drive flange, allowing the use of a snap in valve body cap. The undercuts of the snap-in coupling features can be made simply by using lifters instead of ejectors and provides for a simple tool design with great benefits. Additionally, this design no longer requires an ultrasonic welding process requires to close the valve body. The design further allows for different thicknesses of filter materials without changing the process. Accordingly, the filter materials within the valve assembly are no longer subjected to ultrasonic forces during the assembly process, which is the most significant issue in the improved filter designs of next generation cartridges. The design will allow for the cap material to be different than the valve material, which is advantageous in allowing more versatility to use other components or conventional components (e.g. syringe tube) and eliminate the need for specialized grease. In some embodiments, the cap can be formed from a liquid silicone resin, which does not have a compression set. Additionally, the substituted material for the valve body will be cheaper than the currently used polycarbonate, and more chemical resistant.

The ultrasonic welding stresses locked into the current polycarbonate valve body assembly design will no longer exist, so the chemical compatibility of the component should be dramatically improved. In one aspect, the order of assembly is now no longer process constrained so that in some embodiments (e.g. Design 2.0), the valve body can be assembled at any point in the process. This includes the valve cap and filter material, which can be assembled at any point in the process

### 14. Gated Near Top of Cartridge Body

The current conventional cartridge body is gated near the top of the cartridge body. Because Design 1.0 is based on conventional tooling techniques, it is also gated in this area.

### 15. Gated near bottom of cartridge body

Because Design 1.0 is based on conventional tooling techniques, it is also gated in this area. Designs 1.5 and 2.0 utilize gating near the bottom of the cartridge. This feature is driven by the fact that the foot is now integrated into the design and there is more opportunity to inject the plastic in this area and may be more beneficial from a mold flow and tool simplicity point of view.

### 16. Integrated Lid in Tooling

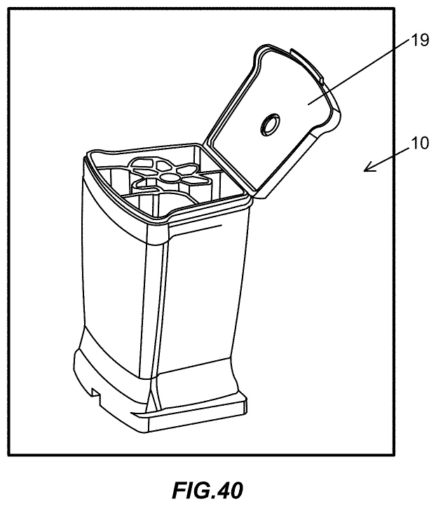

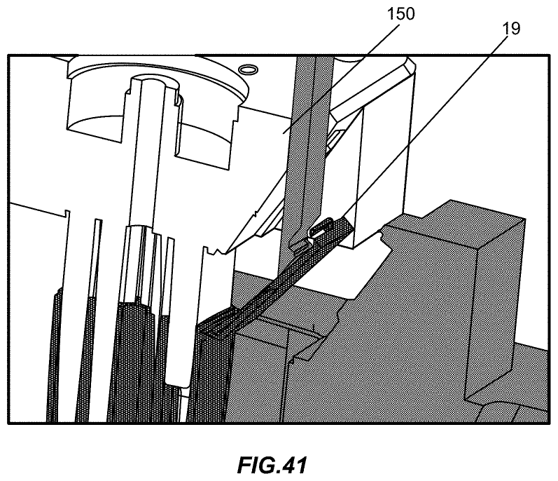

Another feature of the sample cartridge is an integrated lid. FIG. 40 shows an example of an integrated lid 19. This feature, which is used in Design 2.0, is freed of the constraint of using the conventional lid designs. Accordingly, this allows for variations in lid design, such as those described previously. FIG. 41 shows an example tool 150 for forming an integrated lid. The core has the core side of the lid at an angle (e.g. 30 degrees) in the side of its base. The core is an ejector that strips the lid from the core and clears the undercuts of the snap feature at the same time. This action occurs at the end of the molding cycle when the cartridge body is being ejected from the tool. The cavity side of the lid is formed in the front side slide of the cartridge and should separate cleanly. In one aspect, this approach allows the tool to be turned on its side for easier gating, improved sliding action and serviceability.

In the foregoing specification, the invention is described with reference to specific embodiments thereof, but those skilled in the art will recognize that the invention is not limited thereto. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art. Any references to publication, patents, or patent applications are incorporated herein by reference in their entirety for all purposes.

1. A sample cartridge for processing and/or analytical testing of a biological fluid sample, the sample cartridge comprising:
a unitary cartridge body having a plurality of chambers therein and open at a top side of the cartridge body, wherein at least one chamber is configured to receive a fluid sample, wherein the unitary cartridge body further comprises:
a syringe tube integrally defined within the cartridge body, the syringe tube disposed between the plurality of chambers and being open at the top side of the cartridge body;
a valve interface accessible from an underside of the cartridge body, wherein the valve interface comprises a plurality of openings in fluid communication with the plurality of chambers and a bottom opening of the syringe tube; and
a tube mount having one or more fluid ports for communication with one or more fluid ports of a reaction vessel when attached to the cartridge and a coupling feature for securely coupling the reaction vessel to the cartridge.

2. The sample cartridge of claim 1, wherein the syringe tube is dimensioned to facilitate flow of the fluid sample therethrough into the plurality of chambers such that the sample cartridge is operational to process a fluid sample therein without any separate syringe tube.

3. The sample cartridge of claim 1, wherein the coupling feature of the tube mount is a snap-fit design such that the reaction vessel is attachable after the cartridge is fully assembled.

4. The sample cartridge of claim 1, wherein the cartridge body has a consistent wall thickness within a range of 0.5-2 mm.

5. The sample cartridge of claim 1, wherein the unitary cartridge body further includes a base of the cartridge.

6. The sample cartridge of claim 1, wherein the base is integrally formed with the cartridge body.

7. The sample cartridge of claim 5, wherein the base includes an opening on an underside configured for receiving the valve assembly within the cartridge body.

8. The sample cartridge of claim 7, wherein the cartridge body includes a valve interface accessible through the opening in the underside without any disassembly, the valve interface being a negative conical or concave surface.

9. The sample cartridge of claim 1, further comprising:
a valve assembly in fluid communication with the bottom opening of the syringe tube and the plurality of openings of the valve interface.

10. The sample cartridge of claim 9, wherein the valve assembly includes a valve sealing surface on a top side facing the plurality of chambers, wherein the valve sealing surface is a positive conical or convex shape so as to seal against the valve interface of the cartridge body.

11. The sample cartridge of claim 9, wherein the valve assembly comprises:
a valve body having a top side facing the plurality of chambers and a bottom side opposing the top side;
a gasket that is overmolded into the valve body;
a cap attached to the bottom side of the valve body.

12. The sample cartridge of claim 11,
wherein the valve body is generally circular in shape and comprises a coupling feature along a periphery thereof for coupling with the cartridge body, wherein the coupling feature is configured to allow the valve body to rotate while coupled with the cartridge body.

13. The sample cartridge of claim 12, wherein the cap and the valve body comprise corresponding snap-fit coupling features that affix the cap to the valve body.

14. The sample cartridge of claim 12, wherein the coupling feature is a snap-fit feature that extends only partly around the periphery.

15. The sample cartridge of claim 11, wherein the gasket is overmolded by injection molding from the top side of the valve body.

16. The sample cartridge of claim 15, wherein the gasket comprises a valve sealing surface on a top side thereof that engages the valve interface of the cartridge body when the valve assembly is attached thereto, the valve sealing surface having a plurality of holes that align with selected openings of the plurality of openings of the valve interface when the valve assembly is rotated.

17. The sample cartridge of claim 16, wherein the valve sealing surface is non-level and protrudes toward the plurality of chambers of the cartridge.

18. The sample cartridge of claim 17, wherein the valve sealing surface has a convex or positive conical shape.

19. The sample cartridge of claim 11, wherein the valve assembly further comprises a filter chamber defined therein between the valve body and the cap.

20. The sample cartridge of claim 19, wherein the valve body comprises a filter face within the filter chamber that is angled or pitched relative a horizontal plane to facilitate more uniform fluid flow through a filter disposed therein.

21. The sample cartridge of claim 19, wherein the valve body comprises filter support ribs that support the filter within the filter chamber, wherein the filter support ribs are angled along a length thereof to facilitate more uniform fluid flow through a filter disposed therein.

22. The sample cartridge of claim 11, wherein the gasket further comprises one or more sealing rings disposed within or adjacent the filter chamber.

23. The sample cartridge of claim 22, wherein the one or more sealing rings comprises a sealing ring disposed around the filter chamber.

24. The sample cartridge of claim 22, wherein the one or more sealing rings further comprise a sealing ring disposed around a fluid inlet into the filter chamber.

25. The sample cartridge of claim 1, further comprising:
a valve body comprises a plurality of walls formed integrally with the valve body and protruding from a bottom side of the valve body, wherein the plurality of walls partly define a fluid flowpath and a filter chamber.

26. The sample cartridge of claim 25, further comprising a thin film heat sealed over the plurality of walls to define the flowpath and filter chamber of the valve assembly.

27. The sample cartridge of claim 1, wherein the tube mount comprises a single fluid port.

28. The sample cartridge of claim 27, further comprising:
a reaction vessel attached to the tube mount, wherein the reaction vessel has two fluid channels extending to a reaction chamber and a single fluid port that is coupled to the single fluid port of the sample cartridge.

29. The sample cartridge of claim 28, wherein the other fluid channel is open to atmosphere through a frit of the reaction vessel.

30. The sample cartridge of claim 28, wherein the other fluid channel is closed and includes sufficient headspace for fluid transport through the reaction vessel by application of pressure through the single fluid port.

31. The sample cartridge of claim 1, wherein the tube mount of the sample cartridge comprises two fluid ports that fluidically couple to two fluid ports of the reaction vessel when attached thereto, wherein only one fluid port is in fluid communication with the valve interface.

32. The sample cartridge of claim 31, wherein the other fluid port of the sample chamber is open to atmosphere through a frit of the sample cartridge.

33. The sample cartridge of claim 31, wherein the other fluid port of the sample chamber is in fluid communication with a channel of the fluid sample chamber that is closed and includes sufficient headspace for fluid transport through the reaction vessel by application of pressure through the other fluid port.

34. The sample cartridge of claim 1, wherein the sample cartridge further comprises a top lid for sealing one or more of the plurality of chambers.

35. The sample cartridge of claim 34, wherein the lid is integrally formed with the unitary cartridge body.

36. The sample cartridge of claim 34, further comprising:
a thin film seal between the lid and a top surface of the cartridge body.

37. The sample cartridge of claim 34, wherein the thin film seal is defined by a thin film insert that is disposed between the lid and the top surface of the cartridge body.

38. The sample cartridge of claim 37, wherein the thin film insert is shaped to correspond to a shape of the top surface of the cartridge body and includes a plurality of openings that correspond to the plurality of chambers of the cartridge body.

39. The sample cartridge of claim 37, wherein the lid comprises one or more openings including a major opening, wherein the major opening is disposed over at least one opening of the plurality of openings of the insert to receive the fluid sample therethrough.

40. The sample cartridge of claim 39, wherein at least some openings of the one or more openings of the insert are sealed by the lid and/or an additional thin film seal disposed over the lid so as to seal any reagents and/or processing agents disposed within at least some of the multiple chambers.

41. The sample cartridge of claim 9, wherein the valve assembly includes a magnet secured within.

42. The sample cartridge of claim 41, wherein the magnet is disposed between the filter and the valve body.

43. The sample cartridge of claim 41, wherein the magnet is disposed between the filter and the cap.

44. The sample cartridge of claim 41, wherein the valve interface of the cartridge comprises a magnetic capture chamber disposed adjacent the magnet.

45. The sample cartridge of claim 44, wherein the magnetic capture chamber is integrally formed in the unitary cartridge or is disposed on a separable syringe tube fitted through the syringe tube of the cartridge.

46. A method of forming a sample cartridge for processing and/or analytical testing of a biological fluid sample, the method comprising:
injection molding a unitary cartridge body having a plurality of chambers therein and open at a top side of the cartridge body, wherein at least one chamber is configured to receive a fluid sample, the unitary cartridge body comprising: a syringe tube integrally defined within the cartridge body, the syringe tube disposed between the plurality of chambers and being open at the top side of the cartridge body; and a valve interface surface.

47-55. (canceled)
